(19) United States
(12) Patent Application Publication
(10) Pub. No.: US 2013/0223235 A1
(43) Pub. Date: Aug. 29, 2013

(54) Idle Mode Hybrid Mobility Procedure in a Heterogeneous Network

(71) Applicants: Rose Qingyang Hu, Allen, TX (US); Zhijun Cai, Euless, TX (US); Chandra Sekhar Bontu, Kanata (CA); Mo-Han Fong, Sunnyvale, CA (US); Yi Yu, Irving, TX (US); Yi Song, Plano, TX (US)

(72) Inventors: Rose Qingyang Hu, Allen, TX (US); Zhijun Cai, Euless, TX (US); Chandra Sekhar Bontu, Kanata (CA); Mo-Han Fong, Sunnyvale, CA (US); Yi Yu, Irving, TX (US); Yi Song, Plano, TX (US)

(73) Assignee: RESEARCH IN MOTION LIMITED, Waterloo, ON (CA)

(21) Appl. No.: 13/810,108

(22) PCT Filed: Jul. 14, 2010
(86) PCT No.: PCT/US10/42018

§ 371 Date: May 14, 2013

(51) Int. Cl. H04W 36/30

(52) U.S. Cl. CPC H04W 36/30
USPC 370/242; 370/332; 370/252

(57) ABSTRACT

A UE comprising a processor configured to perform cell selection based on range expansion according to a cell selection criteria that considers both a control channel quality and a data channel quality and further according to a cell ranking criterion. A fall back cell selection may be provided if a coverage hole is detected.

### CROSS REFERENCE

This application is a filing under 35 U.S.C. 371 of International Application No. PCT/US2010/042018 filed Jul. 14, 2010, entitled “Idle Mode Hybrid Mobility Procedures in a Heterogeneous Network” (Atty. Docket No. 38627-WO-PCT-4214-29008) which is incorporated by reference herein as if reproduced in its entirety.

### BACKGROUND

As used herein, the terms “user equipment” (“UE”), “mobile station” (“MS”), and “user agent” (“UA”) might in some cases refer to mobile devices such as mobile telephones, personal digital assistants, handheld or laptop computers, and similar devices that have telecommunications capabilities. The terms “MS,” “UE,” “UA,” user device,” and “user node” may be used synonymously herein. Furthermore the terms “MS,” “UE,” “UA,” user device,” and “user node” can also refer to any component which is hardware or software (alone or in combination) that can terminate a communication session for a user. A UE might include components that allow the UE to communicate with other devices, and might also include one or more associated removable memory modules, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might consist of the device itself without such a module. In other cases, the term “UE” might refer to devices that have similar capabilities but that are not transportable, such as desktop computers, set-top boxes, or network appliances.

As telecommunications technology has evolved, more advanced network access equipment has been introduced that can provide services that were not previously possible. This network access equipment might include systems and devices that are improvements of the equivalent equipment in a traditional wireless telecommunications system. Such advanced or next generation equipment may be included in evolving wireless communications standards, such as Long-Term Evolution (LTE) and LTE-Advanced (LTE-A). For example, an LTE or LTE-A system might be an Evolved Universal Terrestrial Radio Access Network (E-UTRAN) and include an E-UTRAN node B (or eNB), a wireless access point, a relay node, or a similar component rather than a traditional base station. As used herein, the term “eNB” may refer to “eNBs” but may also include any of these systems. These components may also be referred-to as an access node. The terms “eNB” and “access node” may be synonymous in some embodiments.

### BRIEF DESCRIPTION OF THE DRAWINGS

Reference is now made to the following description, taken in connection with the accompanying drawings, wherein like reference numerals may represent like parts.

FIG. 1 is an architectural overview of an LTE system, according to an embodiment of the present disclosure.

FIG. 2 is an example flow for a contention based Random Access Procedure in Rel. 8/9, according to an embodiment of the present disclosure.

FIG. 3 is an example flow for a contention based Random Access Procedure in Rel. 10 IDLE mode, according to an embodiment of the present disclosure.

FIG. 4 is an example cell selection procedure for use in a heterogeneous network, according to an embodiment of the present disclosure.

FIG. 5 is an example cell selection procedure for use in a heterogeneous network, according to an embodiment of the present disclosure.

FIG. 6 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

As used throughout the specification, claims, and Figures, the following acronyms have the following definitions. Unless stated otherwise, all terms are defined by and follow the standards set forth by the Third Generation Partnership Program (3GPP) technical specifications or by the OMA (Open Mobile Alliance).

“BCCH” is defined as “Broadcast Control Channel.”

“CRS” is defined as “Cell-specific Reference Symbol(s).”

“dB” is defined as “decibel.”

“DL” is defined as “Downlink.”

“eICIC” is defined as “Enhanced Inter-Cell Interference Coordination.”

“E-UTRAN” is defined as “Evolved Universal Terrestrial Radio Access Network.”

“eNB” is defined as “E-UTRAN Node B.”

“EPRE” is defined as “Energy Per Resource Element.”

“FDD” is defined as “Frequency Division Duplex.”

“HARQ” is defined as “Hybrid Automatic Repeat Request.”

“Hetnet” is defined as “heterogeneous network”

“IoT” is defined as “Interference Over Thermal.”

“LTE” is defined as “Long Term Evolution.”

“LTE-A” is defined as “LTE-Advanced.”

“MIB” is defined as “Master Information Block.”

“NAS” is defined as “Non-Access Stratum.”

“PCI” is defined as “Physical Cell Identity.”

“PDSCH” is defined as “Physical Downlink Shared Channel.”

“PL” is defined as “Path Loss.”

“PLMN” is defined as “Public Land Mobile Network.”

“RACH” is defined as “Random Access Channel.”

“RAR” is defined as “Random Access Response.”

“RAT” is defined as “Radio Access Technology.”

“Rel-8” is defined as “Release 8 (LTE).”

“Rel-10” is defined as “Release 10 (LTE Advanced).”

RF” is defined as “Radio Frequency.”

“RRC” is defined as “Radio Resource Control.”

“RSRQ” is defined as “Reference Signal Received Quality.”

“RSRP” is defined as “Reference Signal Received Power.”

“RX” is defined as “Reception Power.”

“SIB” is defined as “System Information Block.”

“SIB x” is defined as “System Information Block type x,” where “x” may be a number.

“SINR” is defined as “Signal to Interference plus Noise Ratio.”

“TA” is defined as “Tracking Area.”

“TAU” is defined as “Tracking Area Update.”

“TX” is defined as “Transmission Power.”

“UL” is defined as “Uplink.”

“UTRA” is defined as “Universal Terrestrial Radio Access.”

“UTRAN” is defined as “Universal Terrestrial Radio Access Network.”

“VPLMN” is defined as “Visited Public Land Mobile Network.”

The term “may,” as used herein, can contemplate embodiments in which an object or technique is either required, or possible but not required. Thus, for example, while the term “may” might be used, in some embodiments the term “may” could be replaced by the term “shall” or “must.”

The term “suitable cell” may refer to a cell on which the UE may camp, or otherwise connect-to, in order to obtain normal or other service.

The term “coverage hole” is defined as a region where a UE fails to decode its DL and/or UL control channel and/or data channel with an acceptable packet loss rate. The term “coverage hole” may also be defined as a region where a UE experiences low signal to interference-plus-noise ratio (SINR), below a certain threshold, for a certain period of time.

The term “range expansion” is used to describe the coverage expansion of a low power access node.

The embodiments described herein relate to UE cell selection procedures in a homogenous network. Wireless communication is facilitated by one or more access nodes that establish areas of coverage known as cells. A UE within a cell might communicate over the network by connecting to the access node. In some instances cells overlap, and a UE in an overlapping area might be able to connect to more than one access node. In older networks, the UE might select the cell having the strongest signal strength, and connect to the corresponding access node. However, in heterogeneous networks, this cell selection procedure may not be as efficient as desired.

A heterogeneous network has different kinds of access nodes. For example, a traditional base station with a high transmit power might establish a macro cell, whereas a home base station with a low transmit power might establish a micro cell, pico cell, or femto cell within the macro cell. Each of the latter cells may be increasingly smaller in terms of coverage and signal strength, though there may be advantages to a UE connecting to an access node generating a femto cell, such as a personal home access node, even if the UE could also connect to a macro cell covering the same area. Because the macro cell might be generating a strong signal, cell selection based on downlink signal strength alone may not be as efficient or appropriate as desired.

The embodiments described herein provide for cell selection procedures in a heterogeneous environment. The embodiments described herein provide for cell selection procedures that may not necessarily be based solely on the downlink received signal strength. For example, the embodiments provide for primary cell selection using path loss based metric which will expand the coverage range of low power access nodes. The embodiments also provide for primary cell selection based on biased path loss metric for range expansion. In both embodiments, cell selection/reselection and cell ranking criteria are defined. Additionally, algorithms for using the new selection and ranking criteria are defined, as are mechanisms for communicating the selection criteria among UEs and access nodes.

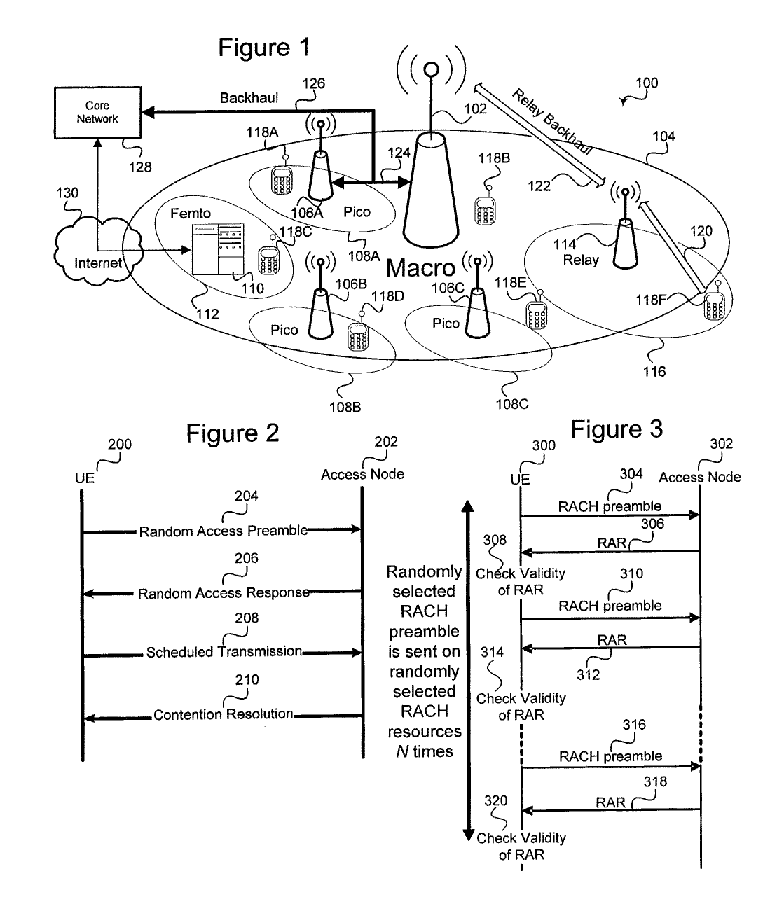

FIG. 1 is an architectural overview of an LTE system, according to an embodiment of the present disclosure. Heterogeneous network 100 is established by several different types of access nodes. Access node 102, which may be an eNB, establishes macro cell 104. Additionally, one or more smaller cells are established by other kinds of access nodes. For example, access nodes 106A, 106B, and 106C establish pico cells 108A, 108B, and 108C, respectively. In another example, access node 110 establishes femto cell 112. In still another example, relay node 114 establishes relay cell 116. The terms “macro,” “micro,” “pico,” and “femto” denote relative sizes and/or signal strengths of the various cells shown in FIG. 1. One benefit to establishing and using a heterogeneous network 100 is significant gains in the network capacity via aggressive spatial spectrum reuse, as well as coverage extensions.

One or more UEs may be serviced in heterogeneous network 100. Each of the UEs shown in FIG. 1 may be a different UE, or may be considered a single UE roaming among the various cells shown in FIG. 1. At different times, a given UE might be serviceable by one cell, but potentially could be serviceable by multiple cells. For example, UE 118A may connect to pico cell 108A or to macro cell 104. Other examples are also shown. UE 118B might be serviceable only by macro cell 104. UE 118C may be serviceable by femto cell 112 or by macro cell 104. UE 118D may be serviceable by pico cell 108B or by macro cell 104. UE 118E may be serviceable by macro cell 104, but is on the edge of pico cell 108C, and thus may or may not be serviceable by pico cell 108C. UE 118F is on the edge of macro cell 104, but is within relay cell 116. Thus, signals from UE 118F may be communicated via relay node 114 to macro access node 102, as shown by arrows 120 and 122. Although several different arrangements of cells and UEs are shown, the embodiments described herein contemplate many different arrangements of cells and UEs.

In addition to the cell and UE arrangements shown in FIG. 1, different techniques exist for communicating among the various kinds of access nodes and the core network 128, which may facilitate wireless communication. For example, access node 102 may communicate with the core network 128 via backhaul 126, which may be wired communications. Different access nodes may communicate directly with each other via a backhaul, as shown by arrows 124. Furthermore, access nodes might communicate directly with the core network 128, such as access node 110 communicating with the core network 128 via the internet 130, or perhaps by some other network. Access nodes may communicate with each other wirelessly, such as between relay access node 114 and access node 102, as indicated by arrows 120 and 122. Again, although several different communication methods and techniques are shown, the embodiments described herein contemplate many different arrangements of communication methods and techniques among the access nodes, as well as among the access nodes and the core network 128. Furthermore, different access nodes may use different technologies.

The Third Generation Partnership Project (3GPP) has begun to extend the Long Term Evolution (LTE) radio access network (RAN). The extended network, which might be represented by heterogeneous network 100, may be referred to as LTE-Advanced (LTE-A). Heterogeneous network 100, as indicated above, may include both high power and low power access nodes to efficiently extend UE's battery life and increase UE throughput. The embodiments described herein provide for handling UE mobility procedures in heterogeneous network 100 to improve UE's performance, especially for the cell edge UEs.

As indicated above, wireless cellular networks may be deployed as homogeneous networks, where all the access nodes are deployed in a planned layout and have similar transmit power levels, antenna patterns, receiver noise floors, and other parameters. In contrast, as indicated above, heterogeneous networks may include a planned placement of macro base-stations that may transmit at high a power level, overlaid with micro access nodes, pico access nodes, femto access nodes, and relay nodes. These access nodes may transmit at substantially lower power levels and may be deployed in a relatively unplanned manner. The low-power access nodes may be deployed to eliminate or reduce coverage holes in the macro-only system and improve capacity in hot-spots. A coverage hole is a geographical area that is not serviceable by a cell, or which cannot receive a desired level of service, or cannot receive a desired type of service.

In a homogeneous LTE network, each mobile terminal may be served by the access node with the strongest signal strength, while the unwanted signals received from other access nodes may be treated as interference. In a heterogeneous network, such schemes may not work well due to the existence of low power access nodes. More intelligent resource coordination among access nodes and better cell selection/reselection strategies may be obtained by the embodiments described herein, thereby possibly providing substantial gains in throughput and user-experience relative to a conventional best power based cell selection.

Range expansion and load balancing based cell selection

A low power access node may be characterized by a substantially lower transmit power relative to a macro access node. One significant difference between the transmit power levels of macro and micro/femto/pico access nodes implies that the downlink coverage of a micro/femto/pico access nodes may be much smaller than that of a macro access node. If cell selection is predominantly based on downlink received signal strength, such as in LTE Rel-8/9, the usefulness of micro, pico, and femto access nodes may be greatly diminished.

For example, the larger coverage of high power access nodes can limit the benefits of cell-splitting by attracting most UEs towards macro access nodes based on the downlink received signal strength, while lower power access nodes may not be serving many users. The difference between the loadings of different access nodes can result in an unfair distribution of data rates and uneven user experiences among the UEs in the network. Enabling range extension and load balancing can allow more UEs to be served by low power access nodes. Range extension of low-power nodes and load balancing may be achieved by proper resource coordination among high power and low power access nodes. This further may help in mitigating the strong interference caused by UL/DL imbalance.

The embodiments provide for a hybrid cell selection scheme during UE IDLE mode in a heterogeneous network. The hybrid cell selection scheme may enhance the existing range expansion and load balancing based cell selection scheme by preventing UEs from falling into a coverage hole due to improper cell planning or inter-cell interference coordination.

IDLE Mode Mobility Procedure

UE procedures in IDLE mode may be specified in two basic steps: cell selection and cell reselection. When a UE is powered on, the UE may select a suitable cell based on the IDLE mode measurements and cell selection criteria. The UE may use one of the following two cell selection procedures. The initial cell selection procedure requires no prior knowledge of which RF channels are E-UTRA carriers. The UE may scan all RF channels in the E-UTRA bands according to its capabilities to find a suitable cell. On each carrier frequency, the UE may search for the strongest cell. Once a suitable cell is found, this cell may be selected. The stored information cell selection procedure may use stored information of carrier frequencies and optionally also information on cell parameters, from previously received measurement control information elements or from previously detected cells. Once the UE has found a suitable cell the UE may select the suitable cell. If no suitable cell is found, the initial cell selection procedure may be started.

A suitable cell may fulfill the cell selection criteria S, which may be defined as:

Srxlev>0 AND Squal>0 (1)

Where:

Srxlev=Qᵣₓₗₑᵥₘₑₐₛ−(Qᵣₓₗₑᵥₘᵢₙ+Q_{rxlevminoffset})−Pcompensation

Squal=Q_{qualmeas}−(Q_{qualmin}+Q_{qualminoffset})

| Srxlev | is | Cell selection RX level value (dB) |
|---|---|---|
| Squal | is | Cell selection quality value (dB) |
| Qᵣₓₗₑᵥₘₑₐₛ | is | Measured cell RX level value (RSRP) |
| Q_{qualmeas} | is | Measured cell quality value (RSRQ) |
| Qᵣₓₗₑᵥₘᵢₙ | is | Minimum required RX level in the cell (dBm) |
| Q_{qualmin} | is | Minimum required quality level in the cell (dB) |
| Q_{rxlevminoffset} | is | Offset to the signaled Qᵣₓₗₑᵥₘᵢₙ taken into account |
| | | in the Srxlev evaluation as a result of a periodic |
| | | search for a higher priority PLMN while camped |
| | | normally in a VPLMN |
| Q_{qualminoffset} | is | Offset to the signaled Q_{qualmin}D taken into account |
| | | in the Squal evaluation as a result of a periodic |
| | | search for a higher priority PLMN while camped |
| | | normally in a VPLMN |
| Pcompensation | is | max(P_{EMAX}_{_{—}}_{H} − P_{PowerClass}, 0) (dB) |
| P_{EMAX}_{_{—}}_{H} | is | Maximum TX power level an UE may use when |
| | | transmitting on the uplink in the cell (dBm) defined |
| | | as P_{EMAX}_{_{—}}_{H} in [TS 36.101] |
| P_{PowerClass} | is | Maximum RF output power of the UE (dBm) |
| | | according to the UE power class as defined in [TS |
| | | 36.101] |

When camped on a cell, the UE may regularly search for a better cell according to the cell reselection criteria. If a better cell is found, that cell may be re-selected, for example, to initiate the E-UTRAN network attachment procedure in the future.

E-UTRAN Inter-Frequency and Inter-RAT Cell Reselection Criteria

In the case of E-UTRAN inter-frequency and inter-RAT cell reselection, the priority-based reselection criterion may be applied. Absolute priorities of different E-UTRAN frequencies or inter-RAT frequencies may be provided to the UE in the system information, or in the RRCConnectionRelease message, or by inheriting from another RAT at inter-RAT cell selection or reselection. The UE may reselect the new cell if the following conditions are met. First, that the new cell is better ranked than the serving cell and all the neighboring cells during a time interval TreselectionRAT. Second, that more than 1 second has elapsed since the UE camped on the current serving cell.

Intra-Frequency and Equal Priority Inter-Frequency Cell Reselection Criteria

In the case of the intra-frequency and equal priority inter-frequency cell reselection, a cell ranking procedure may be applied in order to identify the best cell. The cell-ranking criterion Rₛ for serving cell and Rₙ for neighboring cells may be defined as follows:

Rₛ=Q_{meas,s}+Q_{Hyst}

Rₙ=Q_{meas,n}−Qoffset (2)

### Where:

| | | |
|---|---|---|
| Qₘₑₐₛ | is | RSRP measurement quantity used in cell reselections. |
| Qoffset | is | For intra-frequency: Equals to Qoffset_{s,n}, if Qoffset_{s,n} is |
| | | valid, otherwise this equals to zero. |
| | | For inter-frequency: Equals to Qoffset_{s,n} plus |
| | | Qoffset_{frequency}, if Qoffset_{s,n} is valid, |
| | | otherwise this equals to Qoffset_{frequency}. |
| Q_Hyst | is | Specifies the hysteresis value for ranking criteria, broadcast |
| | | in serving cell system information |

The UE may perform ranking of one or more cells that fulfill the cell selection criterion S. The cells may be ranked according to the R criteria specified above, deriving Q_{meas,n} and Q_{meas,s} and calculating the R values using averaged RSRP results. If a cell is ranked as the best cell, the UE may perform cell reselection to that cell. The UE may reselect the new cell if the following conditions are met. First, the new cell is better ranked than the serving cell during a time interval Treselection_{RAT}. Second, more than 1 second has elapsed since the UE camped on the current serving cell.

Cell Selection/Reselection Schemes in a Hetnet

When the UE performs an IDLE mode mobility procedure, such as intra-frequency cell selection/reselection, the UE should normally choose the best cell. The best cell may be in some instances the cell with the best link quality. Currently, in LTE Rel. 8/9, the UE will rank the cells based on the measured RSRP and/or RSRQ. Other measurement may also apply.

This technique may work well in a traditional homogeneous network, where all the access nodes have similar level of transmit power levels. However, in a heterogeneous network, due to the mixed deployment of low power and high power nodes, other considerations may be taken into account. An improper cell selection may lead to very frequent handovers or cell reselections in a heterogeneous network. One serving cell selection scheme uses best power based cell selection/reselection. In this scheme, each UE selects its serving cell which has the maximum average reference signal received power (RSRP), such as in the following equation:

Serving Cell=arg maxᵢRSRPᵢ (3)

Another cell selection/reselection scheme may be range expansion based on path loss. In this scheme, each UE may select the serving cell to which each UE experiences the minimum path loss. This path loss may include one or more of a) the fixed and variable components of distance-related propagation losses, b) the antenna gains between the UE to each cell, c) the log normal shadow fading, and d) any penetration losses. In one example, this cell selection scheme may be represented by the following equation:

Serving Cell=arg minᵢPL_{i,dB}=arg minᵢ(P_{tx,i,dB}−RSRP_{i,dB}). (4)

Here P_{tx,i,dB} is the transmission power of the i^{th} access node and P_{Li, dB} is the PL between the UE and the i^{th} access node. Both values may be expressed in dBm.

Another cell selection/reselection scheme may be range expansion based on a biased reference signal received power (RSRP). This scheme may bias users in favor of selecting a low power cell by adding a bias to its RSRP value. Therefore, the UE may select its serving cell according to the following equation:

Serving Cell=arg maxᵢ(RSRP_{i,dB}+Bias_{i,dB}). (5)

The parameter, Bias_{i, dB} (bias with respect to the i^{th} access node) may be chosen to be a positive, non-zero value whenever the candidate cell i corresponds to a low power access node. The value of this parameter may equal 0 dB, otherwise. In some other embodiments, the value of this parameter could be a negative value as well. This parameter may be signaled to the UE via high layer signaling such as RRC signaling, MAC control elements, etc.

Issues

Studies have shown that by using range expansion, more UEs can camp on the low power access nodes so that their bandwidth may be more efficiently utilized and also so that load among different cells may be more evenly distributed. However, for some UEs associated with micro-access nodes by using range expansion, undesirable interference may be experienced as a result of high power nodes on the downlink, because these UEs may receive higher power from some other nodes, and thus will have very poor geometry. Thus, effective interference coordination and resource coordination schemes are desirable in a heterogeneous network. The level of interference coordination may depend on how UE cell selection is conducted. For example, cell selection/reselection based on different bias values may have an impact on the choice of interference coordination scheme. If the bias is 0, the scheme may need the smallest level of interference coordination between high power and low power access nodes. The higher the bias, the more coordination may be needed between high power nodes and low power access nodes in order to avoid strong interference to the cell edge UEs associated with the low power access nodes. Furthermore, different interference coordination efforts may be used on the control channel and the data channel. Data channel interference coordination is usually achieved through inter-cell resource coordination or power control. However, control channel interference coordination may be a much more complicated subject.

Coverage Holes

A coverage hole may occur on the UL where the UE experiences transmit power outage while the received signal SINR at the access node is still below the value that corresponds to the lowest modulation and coding rate. A coverage hole may be caused by poor geometry, which may be determined by large scale fading. A coverage hole may also be caused either by a link budget issue or by an interference issue. The former may be decided by the RSRP and later may be decided by the RSRQ. Due to the proper cell deployment, link budget deficiency will usually not be a major concern. Thus, the embodiments described herein primarily concern coverage holes caused primarily by interference, though in some other embodiments coverage holes caused by link budget deficiency may also be considered.

RSRQ based evaluations may be introduced into cell selection. This technique could partially alleviate the coverage hole problem caused by interference. However, this technique may not prevent coverage holes due to one or more of the following.

For example, RSRQ based evaluations may not prevent a coverage hole on the control channel while data channel is working properly. This issue may be severe in a single carrier hetnet scenario, where the interference problem on the control channel may be much more difficult to resolve relative to the data channel. Prior to the embodiments described further below, there has been no effective technique to deal with the control channel interference issue. Thus, a suitable cell for the data channel may not necessarily be a suitable cell for the control channel. The embodiments described herein contemplate measuring control channel and data channel RSRQ separately, so that the UE can perform cell selection based on the knowledge of both values.

Additionally, RSRQ based evaluations may not prevent a coverage hole caused by the fact that the transmission power of CRS could be different from the transmission power of data channel. A UE in the IDLE mode may not know the transmission power difference between them; thus, the RSRQ estimation may not be accurate. In a hetnet, this issue could be worse, relative to other networks, due to tight interference coordination requirements among low power and high power nodes. Because different interference coordination schemes may apply to the control channel and the data channel, CRS tones in the control region and data rejoin may or may not use the same transmission powers among themselves. Furthermore, CRS tones may or may not use the same power transmission compared to data/control tones. All these factors may further impact cell selection accuracy. However, the embodiments described herein address such coverage holes.

Still further, RSRQ based evaluations may not prevent a coverage hole caused by UL/DL imbalance. However, the embodiments described herein address such coverage holes.

IDLE Mode Versus CONNECTED Mode Requirements

One goal of range expansion or biased RSRP cell selection is to expand the footprint or coverage of low power access nodes so that more UEs can benefit from the cell splitting capacity gain offered by low power access nodes. However, the capacity gain in a hetnet by employing range expansion may be mainly applicable for UEs in connected mode. Thus, a UE may gain little by camping on the non-best cell in IDLE mode, at least for capacity purposes. In this case, a UE in IDLE mode may choose, based on the existing reselection rules, a particular cell. However, upon transition to connected mode the UE may be immediately handed over to a different cell that the network prefers to use for the traffic. However, from a practical point view, it may be desirable that the cell selected in IDLE mode will be the same as the cell selected in CONNECTED mode. In this manner, fewer handovers may occur when the UE enters a transition from IDLE mode to CONNECTED mode.

When a UE is in IDLE mode, one or more criteria may be considered. For example, power consumption (for a battery-powered UE) may be an important criterion because a UE may be expected to spend a significant fraction of its time in IDLE mode.

Another criterion may be DL SINR. On the DL, a UE in IDLE mode may monitor paging messages and may occasionally acquire or reacquire broadcast system information. Both of these operations may be facilitated by choosing the access node with the highest observed DL SINR. Note that HARQ retransmissions may not be possible for paging messages, so a higher SINR helps to assure correct decoding of any paging messages that are received. In addition, a higher SINR may reduce the need for possible HARQ combining of system information transmissions, which in turn reduces the power consumption at the UE.

Another criterion may be IoT. On the UL, a UE in IDLE mode may make occasional uplink transmissions, such as tracking area registrations and tracking area updates. If most of the IDLE UEs choose to camp on high power nodes, which may be the case when cell selection is based on best DL power, the UL transmission may need high power from UEs far away from high power nodes. High power transmissions may not be good for UE power saving, nor may high power transmissions be good for overall IoT in the system.

Load balancing is another criterion. If cell selection is based on DL best power, most of the IDLE UEs may camp on high power nodes. In this case, high power nodes may be exposed to excessive UL traffic from tracking area registrations, tracking area updates, RACH activity, and RRC Connection Setup activity. For example, a capacity bottleneck may be caused by a large number of RACH preambles used to avoid collisions.

As a result, there may be several possible IDLE mode cell selection/reselection approaches, each having different advantages and disadvantages. The approaches described below illustrate when an IDLE mode mobility based on new cell selection is needed or desired. In the next section, more detailed embodiments are provided on how cell selection may be performed.

One IDLE mode cell approach may be IDLE mode cell reselection. For UEs in IDLE mode, the range expansion of low power access nodes may be considered by the cell selection and reselection procedures so that 1) the time between two consecutive cell reselections may not be too short and 2) tracking area registration and update related messages may be better distributed among high and low power access nodes. This approach may provide for UE UL power savings, as well as IDLE mode load balancing. However, this approach may need eICIC to handle the DL SINR impact, because UEs may not be connected to the best DL power node. Nevertheless, this issue may not be of concern, because eICIC may be needed or desired for CONNECTED mode UEs, regardless of whether the IDLE mode UEs use or do not use range expansion based cell selection.

Another IDLE mode cell selection approach may be a possible handover immediately following transition to CONNECTED mode. A UE in IDLE mode may use Release 9 cell selection or reselection criteria to choose a cell on which to camp. Thus, the cell with the best signal quality, and which satisfies all of the other relevant selection criteria such as but not limited to the correct PLMN, may be selected. This approach may minimize UE power consumption while in IDLE mode. When such a UE enters CONNECTED mode, the network may take range expansion or load balancing into consideration when determining whether or not to perform a handover of the UE to a different cell in order to improve the overall spectrum efficiency. In this scenario, cell selection may be based on the best RSRP when the UE is performing cell reselection (while in IDLE mode) as well as when the UE is moving to CONNECTED mode. However, range expansion or load balancing may be considered after the UE enters CONNECTED mode. This embodiment may be slightly different than the embodiments described below, where there is a possibility that the UE will start to use range expansion or load balancing based cell selection prior to moving to CONNECTED mode. In this embodiment, impact to the current IDLE mode procedure may be minimized. A UE may have good Idle mode DL coverage even with no eICIC. However, this approach may be more inefficient with respect to UE UL power saving or load balancing of IDLE mode UEs.

Still another IDLE mode cell approach may be intermediate cell reselection prior to entering CONNECTED mode. In this embodiment, a UE in IDLE mode may use Release 9 cell selection and reselection criteria to choose a cell on which to camp. For example, the best cell may be the cell with the best RSRP or RSRQ, and which satisfies all of the other relevant selection criteria such as but not limited to the correct PLMN. This approach may not minimize UE power consumption while in IDLE mode.

Prior to entering CONNECTED mode, such as when the UE is paged or the end user wishes to initiate a connection session, the UE may examine its recent measurements and system information from neighboring cells. In this case, range expansion and load balancing may be considered as new cell selection criteria for this intermediate cell reselection prior to entering connected mode. The UE may reselect to an appropriate neighbor cell, such as a cell which minimizes the total expected consumption of cell resources or which leads to the best load balancing, before commencing the transition from IDLE mode to CONNECTED mode.

This approach is good for RACH, RRC Connection Set up and load balancing. This approach is also good for DL coverage even if there is no eICIC. However, this approach may not help load balancing for tracking area update messages. Furthermore, inherent latency may result because the UE may have to find another cell based on the range expansion criteria to perform RRC connection establishment. This issue may be exacerbated for mobile terminating calls where UE receives a paging message from one cell, and then has to take some time to reselect and acquire system information or reselect and acquire another cell in order to respond to the page. Thus, this approach may perform better for mobile originated calls.

In the above approaches, an issue may be how to avoid a coverage hole on the control channel when the cell selection or association is based on range expansion or load balancing. For example, with respect to the IDLE mode cell reselection approach and the intermediate cell reselection prior to entering CONNECTED mode approach, the UE may not be able to receive paging or perform RRC connection establishment due to poor DL SINR, if there is no effective eICIC available.

IDLE Mode Hybrid Cell Selection/Reselection

The embodiments described herein provide for at least three overall techniques for handling UE cell selection in heterogeneous networks. A first technique may use both control channel RSRQ and data channel RSRQ in cell selection/reselection to prevent a coverage hole. A second technique may use different RSRP/RSRQ bias values among different cells so that the UE can camp on the cells with reasonable RSRQ, and a hetnet can still provide load balancing. A third technique may allow UE fallback to best power based cell selection if a coverage hole is detected.

A hybrid cell selection/association scheme may use a Rel.10 cell selection scheme as the primary scheme, but fall back to Rel.8/9 cell selection schemes once a coverage hole is detected. A hybrid cell selection/association scheme does not need to specify the primary cell selection/association mechanism. In other words, any primary cell selection/association mechanism can fall back to Rel.8/9 “best power” based cell selection if a coverage hole is detected. Both primary cell selection and fall back cell selection may consider data channel RSRQ as well as control channel RSRQ. The following two different solutions may be applied to IDLE mode cell selection in either the first technique (the UE uses the new cell selection scheme in IDLE mode) or the third technique (the UE uses the new cell selection just before it enters CONNECTDED mode from IDLE mode).

Primary Cell Selection Using Path Loss Based Range Expansion

In one embodiment, primary cell selection may be path loss based range expansion. Once primary cell selection fails, the fallback cell selection may be based on the Rel. 9 scheme. The path loss may be estimated by the UE in dB using the following equation:

PL=referenceSignalPower−higher layer filtered RSRP

ReferenceSignalPower is the downlink reference signal EPRE from the access node, as defined in TS 36.213. A new S criterion may be used that considers both control channel and data channel quality. This new S criterion is defined below.

New S Criteria Definition

In an embodiment, a suitable cell on which a UE may camp may fulfill the cell selection criteria S defined as follows:

Srxlev>0 AND Squal_{—}D>0 AND Squal_{—}C>0 (6)

Srxlev=Qᵣₓₗₑᵥₘₑₐₛ−(Qᵣₓₗₑᵥₘᵢₙ+Q_{rxlevminoffset})−Pcompensation

Squal_{—}D=Q_{qualmeasD}−(Q_{qualminD}+Q_{qualminoffsetD})

Squal_{—}C=Q_{qualmeasC}−(Q_{qualminC}+Q_{qualminoffsetC})

### Where:

| | | |
|---|---|---|
| Srxlev | is | Cell selection reception power level value (decibels) |
| Squal_D | is | Cell selection quality value (decibels) for a data |
| | | channel |
| Squal_C | is | Cell selection quality value (decibels) for a control |
| | | channel |
| Qᵣₓₗₑᵥₘₑₐₛ | is | Measured cell reception power level value |
| | | (Reference Signal Received Power) |
| Q_{qualmeasD} | is | Measured cell quality value (Reference Signal |
| | | Received Quality) for a data channel |
| Q_{qualmeasC} | is | Measured cell quality value (Reference Signal |
| | | Received Quality) for a control channel |
| Qᵣₓₗₑᵥₘᵢₙ | is | Minimum required reception power level in the cell |
| | | (decibels) |
| Q_{qualminD} | is | Minimum required quality level in the cell (decibels) |
| | | for data channel |
| Q_{qualminC} | is | Minimum required quality level in the cell (decibels) |
| | | for a control channel |
| Q_{rxlevminoffset} | is | Offset to the signaled Qᵣₓₗₑᵥₘᵢₙ taken into account in |
| | | the Srxlev evaluation as a result of a periodic search |
| | | for a higher priority public land mobile network |
| | | while camped normally in a visited public land |
| | | mobile network |
| Q_{qualminoffsetD} | is | Offset to the signalled Q_{qualmin}D taken into account |
| | | in the Squal_D evaluation as a result of a |
| | | periodic search for a higher priority public land |
| | | mobile network while camped normally in a visited |
| | | public land mobile network |
| Q_{qualminoffsetC} | is | Offset to the signalled Q_{qualmin}C taken into account |
| | | in the Squal_C evaluation as a result of a |
| | | periodic search for a higher priority public land |
| | | mobile network while camped normally in a visited |
| | | public land mobile network |
| Pcompensation | is | max(P_{EMAX}_{_{—}}_{H} − P_{PowerClass}, 0) (decibels) |
| P_{EMAX}_{_{—}}_{H} | is | Maximum transmission power level a user |
| | | equipment uses when transmitting on the uplink in |
| | | the cell (decibels) defined as P_{EMAX}_{_{—}}_{H} in [technical |
| | | specification 36.101] |
| P_{PowerClass} | is | Maximum radio frequency output power of the user |
| | | equipment (decibels) according to the user |
| | | equipment power class as defined in [technical |
| | | specification 36.101] |

The data channel quality and control channel quality may be measured separately. This technique is different from the Rel.8 and Rel.9 definitions. In Rel. 8, the S criteria only considers Srxlev, while Rel.9 considers both Srxlev and Squal. In the embodiment described herein, Squal is further split into Squal_D and Squal_C to more accurately capture the difference in data channel and control channel in a heterogeneous network. In some embodiments, the parameters used in calculating Squal_D and Squal_C may or may not be the same. Based on the new criteria, the following measurement rules may be changed as well.

For Inter-RAT, the UE may search for and measure inter-RAT frequencies of higher priority. If Srxlev≧S_{nonintrasearchP} and Squal_D>S_{nonIntrasearchQ-D}, and Squal_C>S_{nonIntraSearchQ-C}, then the UE may choose not to search for inter-RAT frequencies of equal or lower priority. Otherwise, the UE may search for and measure inter-RAT frequencies of equal or lower priority in preparation for possible reselection.

For Inter-frequency, the UE may search for and measure inter-frequency neighbors of higher priority. If Srxlev≧S_{nonintrasearchP}, Squal_D>S_{nonIntraSearchQ-D}, and Squal_C>S_{nonIntraSearchQ-C}, then the UE may choose not to search for inter-frequency neighbors of equal or lower priority. Otherwise, the UE may search for and measure inter-frequency neighbors of, equal or lower priority in preparation for possible reselection

For Intra-frequency, if the serving cell fulfills Srxlev>S_{IntraAearchP}, Squal_D>S_{IntraSearchQ-D}, and Squal_C>S_{IntraSearchQ-C}, then the UE may choose not to perform intra-frequency measurements. Otherwise, the UE may perform intra-frequency measurements.

The new cell measurement parameters may be defined as follows:

S_{nonIntraSearchQ-D}
This specifies the Squal_D threshold (in dB) for E-UTRAN
inter-frequency and inter-RAT measurements
S_{nonIntraSearchQ-C}
This specifies the Squal_C threshold (in dB) for E-UTRAN
inter-frequency and inter-RAT measurements.
S_{IntraSearchQ-D}
This specifies the Squal_D threshold (in dB) for intra-frequency
measurements.
S_{IntraSearchQ-C}
This specifies the Squal_C threshold (in dB) for intra-frequency
measurements.

The S criteria defined above may impact the SIB1 and SIB3 messages. Examples of how these messages may be impacted are provided below. For example, the SIB1 may be changed as follows, with the changes shown in italics.

-- ASN1START

| | |
|---|---|
| SystemInformationBlockType1 ::= | SEQUENCE { |

| | |
|---|---|
| cellAccessRelatedInfo | SEQUENCE { |

| plmn-IdentityList | PLMN-IdentityList, | | |
|---|---|---|---|
| trackingAreaCode | TrackingAreaCode, | | |
| cellIdentity | CellIdentity, | | |
| cellBarred | ENUMERATED {barred, notBarred}, | | |
| intraFreqReselection | ENUMERATED {allowed, notAllowed}, | | |
| csg-Indication | BOOLEAN, | | |
| csg-Identity | CSG-Identity-r9 | OPTIONAL | -- Need OR |

| }, | |
|---|---|
| cellSelectionInfo | SEQUENCE { |

| q-RxLevMin | Q-RxLevMin, | | |
|---|---|---|---|
| q-RxLevMinOffset | INTEGER (1..8) | OPTIONAL | -- Need OP |

| }, | | | |
|---|---|---|---|
| p-Max | P-Max | OPTIONAL, | -- Need |

OP

| freqBandIndicator | INTEGER (1..64), | | |
|---|---|---|---|
| schedulingInfoList | SchedulingInfoList, | | |
| tdd-Config | TDD-Config | OPTIONAL, | -- Cond TDD |

| | |
|---|---|
| si-WindowLength | ENUMERATED { |

ms1, ms2, ms5, ms10, ms15, ms20,
ms40},

| | |
|---|---|
| systemInfoValueTag | INTEGER (0..31), |
| nonCriticalExtension | SystemInformationBlockType1-v9x0-IEs |

| | |
|---|---|
| OPTIONAL | -- Need OP |

}

| | |
|---|---|
| PLMN-IdentityList ::= | SEQUENCE (SIZE (1..6)) OF PLMN-IdentityInfo |
| PLMN-IdentityInfo ::= | SEQUENCE { |

| | |
|---|---|
| plmn-Identity | PLMN-Identity, |
| cellReservedForOperatorUse | ENUMERATED {reserved, notReserved} |

}
SchedulingInfoList ::= SEQUENCE (SIZE (1..maxSI-Message)) OF SchedulingInfo
SchedulingInfo ::= SEQUENCE {

| | |
|---|---|
| si-Periodicity | ENUMERATED { |

rf8, rf16, rf32, rf64, rf128, rf256, rf512},

| | |
|---|---|
| sib-MappingInfo | SIB-MappingInfo |

}
SIB-MappingInfo ::= SEQUENCE (SIZE (0..maxSIB-1)) OF SIB-Type

| | |
|---|---|
| SIB-Type ::= | ENUMERATED { |

sibType3, sibType4, sibType5, sibType6,
sibType7, sibType8, sibType9, sibType10,
sibType11, sibType12-v9x0, sibType13-v9x0, spare5,
spare4, spare3, spare2, spare1, ...}

SystemInformationBlockType1-v9x0-IEs::= SEQUENCE {

| | | | |
|---|---|---|---|
| imsEmergencySupportIndicator-r9 | ENUMERATED {supported} | OPTIONAL, | -- Need |

OP

| | | | |
|---|---|---|---|
| cellSelectionInfo-v9x0 | CellSelectionInfo-v9x0 | OPTIONAL, | -- Need |

OP

| | | | |
|---|---|---|---|
| cellSelectionInfo-v10x0 | CellSelectionInfo-v10x0 | OPTIONAL, | -- Need |

OP

| | | | |
|---|---|---|---|
| nonCriticalExtension | SEQUENCE { } | OPTIONAL | -- Need |

OP
}

| CellSelectionInfo-v10x0 ::= | | SEQUENCE { | | |
|---|---|---|---|---|
| | q-QualMinD | Q-QualMin-D, | OPTIONAL | -- Need |

OP

| | | | |
|---|---|---|---|
| q-QualMinC | Q-QualMin-C, | OPTIONAL | -- Need |

OP

| | | | |
|---|---|---|---|
| q-QualMinOffset-D | INTEGER (1..8) | OPTIONAL | -- Need |

OP

| | | | |
|---|---|---|---|
| q-QualMinOffset-C | INTEGER (1..8) | OPTIONAL | -- Need |

OP
}
-- ASN1STOP

### Where:

q-QualMinD
This field may be used for Q_{qualminD} described above.
q-QualMinC
This field may be used for Q_{qualminC} described above.
q-QualMinOffset-D
This field may be used for Q_{qualminoffsetD} described above.
q-QualMinOffset-C
This field may be used for Q_{qualminoffsetC} described above.

The SIB3 may be changed as follows, with the changes shown in italics.

-- ASN1START

| | |
|---|---|
| SystemInformationBlockType3 ::= | SEQUENCE { |

| | |
|---|---|
| cellReselectionInfoCommon | SEQUENCE { |

| | |
|---|---|
| q-Hyst | ENUMERATED { |

dB0, dB1, dB2, dB3, dB4, dB5, dB6, dB8, dB10,
dB12, dB14, dB16, dB18, dB20, dB22, dB24},

| | |
|---|---|
| speedStateReselectionPars | SEQUENCE { |

| | |
|---|---|
| mobilityStateParameters | MobilityStateParameters, |

| | |
|---|---|
| q-HystSF | SEQUENCE { |

| | |
|---|---|
| sf-Medium | ENUMERATED { |

dB-6, dB-4, dB-2, dB0},

| | |
|---|---|
| sf-High | ENUMERATED { |

dB-6, dB-4, dB-2, dB0}

}

| | | |
|---|---|---|
| } | OPTIONAL | -- Need |

OP

| }, | |
|---|---|
| cellReselectionServingFreqInfo | SEQUENCE { |

| | | | |
|---|---|---|---|
| s-NonIntraSearch | ReselectionThreshold | OPTIONAL, | -- Need |

OP

| | |
|---|---|
| threshServingLow | ReselectionThreshold, |
| cellReselectionPriority | CellReselectionPriority |

| }, | |
|---|---|
| intraFreqCellReselectionInfo | SEQUENCE { |

| q-RxLevMin | Q-RxLevMin, | | |
|---|---|---|---|
| p-Max | P-Max | OPTIONAL, | -- Need |

OP

| | | | |
|---|---|---|---|
| s-IntraSearch | ReselectionThreshold | OPTIONAL, | -- Need |

OP

| | | | |
|---|---|---|---|
| allowedMeasBandwidth | AllowedMeasBandwidth | OPTIONAL, | -- Need |

OP

| presenceAntennaPort1 | PresenceAntennaPort1, | | |
|---|---|---|---|
| neighCellConfig | NeighCellConfig, | | |
| t-ReselectionEUTRA | T-Reselection, | | |
| t-ReselectionEUTRA-SF | SpeedStateScaleFactors | OPTIONAL | -- Need |

OP

| }, | |
|---|---|
| ..., | |
| [[s-IntraSearch-v10x0 | SEQUENCE { |

| | |
|---|---|
| s-IntraSearchP-r10 | ReselectionThreshold, |
| s-IntraSearchQ-D-r10 | ReselectionThresholdQ-D-r10 |
| s-IntraSearchQ-C-r10 | ReselectionThresholdQ-C-r10 |

| | | |
|---|---|---|
| } | OPTIONAL, | -- Need |

OP

| | |
|---|---|
| s-NonIntraSearch-v10x0 | SEQUENCE { |

| | |
|---|---|
| s-NonIntraSearchQ-D-r10 | ReselectionThresholdQ-D-r10, |
| s-NonIntraSearchQ-C-r10 | ReselectionThresholdQ-C-r1 |

| | | |
|---|---|---|
| } | OPTIONAL, | -- Need |

OP

]]

}
-- AS
N1STOP

### Where:

s-IntraSearchP-r10
This field may be used for S_{nonintrasearchP} in Rel. 10
s-IntraSearchQ-D-r10
This field may be used for S_{IntraSearchQ-D} in Rel. 10
s-IntraSearchQ-C-r10
This field may be used for S_{IntrasearchQ-C} in Rel. 10
s-NonIntraSearchQ-D-r10
This field may be used for S_{nonIntraSearchQ-D} in Rel. 10
s-NonIntraSearchQ-C-r10
This field may be used for S_{nonIntraSearchQ-C} in Rel. 10

In addition to a new S criterion, the embodiments also contemplate new R criteria definitions. In an embodiment, the cell-ranking criterion Rs for serving cell and Rn for neighboring cells may be defined as:

Rₛ=PL_{meas,s}−Q_Hyst_pl

Rₙ=PL_{meas,n}+Qoffset_pl (7)

### Where:

| | | |
|---|---|---|
| PLₘₑₐₛ | is | Path loss measurement quantity used in cell |
| | | reselections. |
| PLmeas,s | is | Pathloss measurement quantity in the serving |
| | | cell used in cell selection or reselection. |
| PLmeas,n | is | Pathloss measurement quantity in neighbouring |
| | | cell used in cell reselections. |
| Qoffset_pl | is | For intra-frequency: Equals to Qoffset_pl_{s,n}, |
| | | if Qoffset_pl_{s,n} is valid, otherwise this |
| | | equals to zero. |
| | | For inter-frequency: Equals to Qoffset_pl_{s,n} plus |
| | | Qoffset_{frequency}, if Qoffset_{s,n} is valid, otherwise |
| | | this equals to Qoffset_{frequency.} |
| Q_Hyst_pl | is | Specifies the hysteresis value for ranking criteria, |
| | | broadcast in serving cell system information. |

The R criteria defined above may be called R1 for primary cell selection using path loss based range expansion. The cell with the smallest R criteria may be selected. The RSRP may be the measured signal strength. In an embodiment, SIB4 and SIB5 message may contain neighboring cell related information relevant for intra-frequency and inter-frequency cell re-selection. A parameter, referenceSignalPower, may be added to the neighboring cell information to tell the reference signal transmission power of neighboring cells in both the SIB4 and SIB5 messages. Also Q_Hyst_pl may be added to the SIB3 message and Qoffset_pl may be added to the SIB4 and SIB5 messages as follows.

The following is an example of a SIB3 message for the serving cell using R1. Changes are shown in italics.

-- ASN1START

| | |
|---|---|
| SystemInformationBlockType3 ::= | SEQUENCE { |

| | |
|---|---|
| cellReselectionInfoCommon | SEQUENCE { |

| | |
|---|---|
| q-Hyst | ENUMERATED { |

dB0, dB1, dB2, dB3, dB4, dB5, dB6, dB8, dB10,
dB12, dB14, dB16, dB18, dB20, dB22, dB24},

| | |
|---|---|
| q-Hyst-pl | ENUMERATED { }, |

| | |
|---|---|
| OPTIONAL | -- Cont Hetnet |

| | |
|---|---|
| speedStateReselectionPars | SEQUENCE { |

| | |
|---|---|
| mobilityStateParameters | MobilityStateParameters, |

| | |
|---|---|
| q-HystSF | SEQUENCE { |

| | |
|---|---|
| sf-Medium | ENUMERATED { |

dB-6, dB-4, dB-2, dB0},

| | |
|---|---|
| sf-High | ENUMERATED { |

dB-6, dB-4, dB-2, dB0}

}

| | | |
|---|---|---|
| } | OPTIONAL | -- Need |

OP

| }, | |
|---|---|
| cellReselectionServingFreqInfo | SEQUENCE { |

...,

| }, | |
|---|---|
| IntraFreqCellReselectionInfo | SEQUENCE { |

...,

},
...,

}
-- ASN1STOP

The following is an example of a SIB4 message for the intra-frequency neighboring cells using R1. Changes are shown in italics.

-- ASN1START

| | |
|---|---|
| SystemInformationBlockType4 ::= | SEQUENCE { |

| | | | |
|---|---|---|---|
| intraFreqNeighCellList | IntraFreqNeighCellList | OPTIONAL, | -- Need OR |

| | | | |
|---|---|---|---|
| intraFreqBlackCellList | IntraFreqBlackCellList | OPTIONAL, | -- Need |

OR

| | | | |
|---|---|---|---|
| csg-PhysCellIdRange | PhysCellIdRange | OPTIONAL, | -- Cond CSG |

...

}

| | |
|---|---|
| IntraFreqNeighCellList ::= | SEQUENCE (SIZE (1..maxCellIntra)) OF IntraFreqNeighCellInfo |
| IntraFreqNeighCellInfo ::= | SEQUENCE { |

| physCellId | PhysCellId, | | |
|---|---|---|---|
| q-OffsetCell | Q-OffsetRange, | | |
| q-offsetCell_{—}pl | Q-offset-plRange | OPTIONAL | --Cond Hetnet |
| referenceSignalPower | INTEGER (−60..50), | OPTIONAL | -- Cond Hetnet |

...

}

| | |
|---|---|
| IntraFreqBlackCellList ::= | SEQUENCE (SIZE (1..maxCellBlack)) OF PhysCellIdRange |

-- ASN1STOP

The following is an example of a SIB5 message for the inter-frequency neighboring cells using R1. Changes are shown in italics.

-- ASN1START

| | |
|---|---|
| SystemInformationBlockType5 ::= | SEQUENCE { |

| | |
|---|---|
| interFreqCarrierFreqList | InterFreqCarrierFreqList, |

| ..., | | | |
|---|---|---|---|
| lateR8NonCriticalExtension | OCTET STRING | OPTIONAL | -- Need OP |

}

| | |
|---|---|
| InterFreqCarrierFreqList ::= | SEQUENCE (SIZE (1..maxFreq)) OF InterFreqCarrierFreqInfo |

| | |
|---|---|
| InterFreqCarrierFreqInfo ::= | SEQUENCE { |

...,

}

| | |
|---|---|
| InterFreqNeighCellList ::= | SEQUENCE (SIZE (1..maxCellInter)) OF InterFreqNeighCellInfo |
| InterFreqNeighCellInfo ::= | SEQUENCE { |

| | |
|---|---|
| physCellId | PhysCellId, |
| q-OffsetCell | Q-OffsetRange |

| | | | |
|---|---|---|---|
| q-offsetCell_{—}pl | Q-offset-plRange | OPTIONAL | --Cond Hetnet |
| referenceSignalPower | INTEGER (−60..50), | OPTIONAL | -- Cond Hetnet |

}

| | |
|---|---|
| InterFreqBlackCellList ::= | SEQUENCE (SIZE (1..maxCellBlack)) OF PhysCellIdRange |

-- ASN1STOP

In another embodiment, a similar R criteria format as defined in Rel. 9 may be used in the hybrid cell selection scheme described herein. However, the embodiments may provide for two sets of Qoffset parameters. Qoffset1 may be used to offset the macro or micro/femto/pico access node transmission power. The new R criteria, which may be called R2 for primary cell selection using path loss based range expansion, may be defined as follows, with Rs being the ranking criteria for the serving cell and RN being the ranking criteria for the neighboring cell.

Rₛ=Q_{meas,s}+Q_{Hyst}

Rₙ=Q_{meas,n}−Qoffset1−Qoffset (8)

| | | |
|---|---|---|
| Qₘₑₐₛ | is | RSRP measurement quantity used in cell reselections. |
| Qoffset1 | is | Defined as the reference signal power |
| | | difference between two cells n,s, i.e, |
| | | ReferenceSiganlPower_n − ReferenceSignalPower_s. |
| Qoffset | is | For intra-frequency: Equals to Qoffset_{s,n}, if Qoffset_{s,n} |
| | | is valid, otherwise this equals to zero. |
| | | For inter-frequency: Equals to Qoffset_{s,n} plus |
| | | Qoffset_{frequency}, if Qoffset_{s,n} is valid, |
| | | otherwise this equals to Qoffset_{frequency}. |
| Q_Hyst | is | Specifies the hysteresis value for ranking criteria, |
| | | broadcast in serving cell system information |

The cell with the largest R criteria may be selected. A new offset Qoffset1 may be introduced in order to allow the UE to use PL based cell selection under normal conditions while using “best power” based cell selection as a fall back mechanism when a coverage hole is detected. In this case, a UE may have more freedom to make its own decision in IDLE mode. In other words, the Qoffset may be used to enable the R8/9 reselection criteria to operate unaffected by other changes described herein. Furthermore, the parameter Qoffset1 may be additionally applied to achieve the new R10 reselection behavior. These facts may also apply to other embodiments described herein.

A new parameter, q-offsetCell1, may be added to the neighboring cell information SIB4/SIB5 messages to count the reference signal power difference between the neighboring cell and the serving cell. The following is an example of a new SIB4 message for intra-frequency neighboring cells for R2. Changes are shown in italics.

-- ASN1START

| | |
|---|---|
| SystemInformationBlockType4 ::= | SEQUENCE { |

| | | | |
|---|---|---|---|
| intraFreqNeighCellList | IntraFreqNeighCellList | OPTIONAL, | -- Need OR |

| | | | |
|---|---|---|---|
| intraFreqBlackCellList | IntraFreqBlackCellList | OPTIONAL, | -- Need |

OR

| | | | |
|---|---|---|---|
| csg-PhysCellIdRange | PhysCellIdRange | OPTIONAL, | -- Cond CSG |

...

}

| | |
|---|---|
| IntraFreqNeighCellList ::= | SEQUENCE (SIZE (1..maxCellIntra)) OF IntraFreqNeighCellInfo |
| IntraFreqNeighCellInfo ::= | SEQUENCE { |

| | |
|---|---|
| physCellId | PhysCellId, |
| q-OffsetCell | Q-OffsetRange, |
| q-offsetCell1 | Q-offsetRange1, OPTIONAL -- Cond Hetnet |

...

}

| | |
|---|---|
| IntraFreqBlackCellList ::= | SEQUENCE (SIZE (1..maxCellBlack)) OF PhysCellIdRange |

-- ASN1STOP

The following is an example of a new SIB5 message for inter-frequency neighboring cells for R2. Changes are shown in italics.

-- ASN1START

| | |
|---|---|
| SystemInformationBlockType5 ::= | SEQUENCE { |

| | |
|---|---|
| interFreqCarrierFreqList | InterFreqCarrierFreqList, |

| ..., | | | |
|---|---|---|---|
| lateR8NonCriticalExtension | OCTET STRING | OPTIONAL | -- Need OP |

}

| | |
|---|---|
| InterFreqCarrierFreqList ::= | SEQUENCE (SIZE (1.. maxFreq)) OF InterFreqCarrierFreqInfo |

| | |
|---|---|
| InterFreqCarrierFreqInfo ::= | SEQUENCE { |

...,

}

| | |
|---|---|
| InterFreqNeighCellList ::= | SEQUENCE (SIZE (1.. maxCellInter)) OF InterFreqNeighCellInfo |
| InterFreqNeighCellInfo ::= | SEQUENCE { |

| | |
|---|---|
| physCellId | PhysCellId, |
| q-OffsetCell | Q-OffsetRange |
| q-offsetCell1 | Q-offsetRange1, OPTIONAL -- Cond Hetnet |

}

| | |
|---|---|
| InterFreqBlackCellList ::= | SEQUENCE (SIZE (1.. maxCellBlack)) OF PhysCellIdRange |

-- ASN1STOP

The information needed to be broadcasted via BCCH for both R1 and R2 could be non-trivial. For example, the parameter referenceSignalPower may use 7 bits for each neighboring cell in SIB4/SIB5 to deliver this information. If there are 160 neighboring access nodes (such as 16 high power neighboring macro-access nodes and 10 micro/pico/femto access nodes within each macro-access node), then 7×160=1120 bits may be used in both SIB4 and SIB5. Although this number of bits may not be an issue for the SIB4/SIB5 messages, using a low overhead solution would still be beneficial. The extra bits may cause a waste of access link bandwidth, may cause a waste of UE's resources (including bandwidth and power), or may cause extra delay.

The embodiments contemplate at least two alternatives to reduce the size of SIB4/SIB5 messages. However, these alternatives may incur more complicated procedures on the UE side.

In a first alternative, applying to R1 and R2, there is no need to exchange the referenceSignalPower among the neighboring access nodes. Hence, the backhaul exchange may not be needed. Each access node may only transmit its own referenceSignalPower in SIB2, which has already been provided in Rel.8/9. The UE may use its previously stored referenceSignalPower for each corresponding cell when calculating Rₛ and Rₙ, above. If there is no previously stored referenceSignalPower for a cell, then the UE may assume a default power level in the above equations. A default power level may be selected as the macro-access node power level in the hetnet configuration. In one embodiment, the default power level default_referenceSignalPower may be provided in SIB2->radioResourceConfigCommonSIB->pdsch-ConfigCommon as shown below. After the default value is stored, the UE may choose not to decode this value, or may choose to decode this value only every given time interval, which might be expressed in seconds. The default value might only be used for the neighboring cells that do not have stored referenceSignalPower values in the current serving cell.

The following is an example of a new SIB2 message including “default_referenceSignalPower” data. Changes are shown in italics.

-- ASN1START

| | |
|---|---|
| PDSCH-ConfigCommon ::= | SEQUENCE { |

| | |
|---|---|
| referenceSignalPower | INTEGER (−60..50), |
| default_{—}referenceSignalPower | Default_{—}ReferenceSignalPower_{—}Range OPTIONAL -- Cont |

Hetnet

| | |
|---|---|
| p-b | INTEGER (0..3) |

}

| | |
|---|---|
| PDSCH-ConfigDedicated::= | SEQUENCE { |

| | |
|---|---|
| p-a | ENUMERATED { |

dB-6, dB-4dot77, dB-3, dB-1dot77,
dB0, dB1, dB2, dB3}

}
-- ASN1STOP

There may be two options after the UE camps on the selected cell, listens to its BCCH, and receives the referenceSignalPower for the camped cell. In a first option, the UE may not perform cell ranking and reselection immediately. The received referenceSignalPower may only apply to the next cell reselection ranking procedure after a time has elapsed, because the UE may camp on the current serving cell. In another option, the UE may apply the received referenceSignalPower and start the cell ranking procedure again to re-rank the cell quality as soon as a time has elapsed, because the UE may camp on the current serving cell. If the current serving cell is still the best cell, the UE may stay in the current cell. If a better cell is found, the UE may switch to the new cell.

A second alternative to reduce the size of SIB4/SIB5 messages, which may apply to both R1 and R2, may be to find a trade-off between the signaling load and cell reselection performance and simplicity. In this hybrid approach, each cell, whether macro or micro/pico/femto/relay, may establish a partial list of referenceSignalPower or q-OffsetCell1. Each cell may transmit this information via the BCCH. For example, the list may only contain the micro-access nodes inside the same macro cell, or the list may be limited to no more than a certain number of neighboring access nodes. The limited set of access nodes may be those access nodes that are closest to the cell that transmits the BCCH. When the UE receives the list, the UE may apply the revised cell ranking formula when performing the cell-reselection ranking procedure. When the best cell is found, if the referenceSignalPower or q-OffsetCell1 of the cell is already included in the list, then no further action may be needed on the UE side. If the referenceSignalPower or q-OffsetCell1 of the cell is not included in the list, then the same approach described above (each access node transmitting its own referenceSignalPower in SIB2) may be used. In this case, SIB4/SIB5 formats may be exactly the same as shown above for both R1 and R2, but with a smaller list of neighboring access nodes for referenceSignalPower or q-OffsetCell1 broadcasting.

A third alternative to reduce the size of SIB4/SIB5 messages may be, instead of broadcasting the referenceSignalPower or q-OffsetCell1 for the serving cell and neighboring cell, to signal a single bit indicator of whether the associated access node is a high power or low power access node. A default value of power difference between the high power node and low power access node may be assumed at the UE, such as for example 15 dB. Thus, the signaling overhead may be significantly reduced, and the UE may still be able to perform cell selection or reselection with the consideration of access node transmission power. This single bit indicator of the serving cell may be added to the SIB2 message, and the indicator for the neighboring cells may be added to the SIB4 or SIB5 messages for the neighboring cells. This scheme may be extended to a multi-bit solution if multiple-level transmission powers exist in the network for different nodes. For example, two bits can handle four different levels of pre-defined transmission powers.

A fourth alternative to reduce the size of SIB4/SIB5 messages may be to broadcast the power class of different cells in different SIB messages. In some cases, the access node power levels may be limited to a few classes, such as for example 46 dBm, 37 dBm, 30 dBm, and 25 dBm. In this case, two bits may be enough to indicate the access node power class. The power class of the serving cell may be broadcast in the SIB2 message and the power classes of the neighboring cells may be broadcasted in the SIB4 and SIB5 messages. The UE may calculate the parameters referenceSignalPower or Qoffset1 by itself. The indicator mapping may be standardized or signaled to the UEs via high layer signaling, such as the BCCH.

Cell Selection and Reselection Procedures

A hybrid cell selection or reselection may be performed as described below. The following procedure is only one example how some of the embodiments described herein may be included into a complete process for inter-RAT, inter-frequency, as well as intra-frequency cell selection and reselection. Other procedures are also contemplated.

First, cell selection may start with UE performing the neighbor cell measurements. For inter-RAT selection, if the Srxlev≧S_{nonintrasearchP}, Squal_D>S_{nonIntraSearchQ-D}, and Squal_C>S_{nonIntraSearchQ-C}, then the UE may search for inter-RAT frequencies of higher priority only. Otherwise, the UE may search for and measure inter-RAT frequencies of higher, lower priority in preparation for possible reselection. For inter-frequency selection, if the Srxlev≧S_{nonintrasearchP}, Squal_D>S_{nonIntraSearchQ-D}, and Squal_C>S_{nonIntraSearchQ-C}, then the UE may search for inter-frequency neighbors of higher priority only. In this case, the UE may search for and measure inter-frequency neighbors of higher, equal or lower priority in preparation for possible reselection. For intra-frequency selection, if the serving cell fulfills Srxlev>S_{IntraSearchP}, Squal_D>S_{IntraSearchQ-D}, and Squal_C>S_{IntraSearchQ-C}, then the UE may choose not to perform intra-frequency measurements. Otherwise, the UE may perform intra-frequency measurements.

Second, once measurements are available, the UE may perform cell selection or reselection as described below. For higher priority inter-RAT or inter-frequency cell ranking and selection, the UE may select all the high priority neighboring cells that satisfy both PL_{neighbor}≦PL_{X,High} and the S criteria described above. If more than one cell satisfies the conditions, the UE may rank the cells based on PL and may select the cell with the lowest path loss. In this case, PL_{X,High} may be the path loss threshold (in dB) used by the UE when reselecting towards a higher priority RAT or frequency than the current serving frequency. Each frequency of E-UTRAN and UTRAN FDD might have a specific threshold. If at least one neighbor cell is found, the UE may camp on the selected cell. If no suitable neighboring cell is found, the UE may try to select a cell following the release 8/9 cell reselection criteria for high priority frequencies. If the UE finds at least one neighbor cell, UE may camp on the selected cell. If multiple neighbor cells are found to satisfy the Rel. 8/9 criteria, the best cell may selected based on the received power. If none of the neighbor cells satisfy the Rel. 8/9 reselection criteria, the UE may try to select inter/intra frequency neighbor cells with the same priority as the serving cell.

In the second step of performing cell selection or reselection, with respect to equal priority inter-frequency or intra-frequency cell ranking and selection, the UE may first perform cell ranking based on the revised R criteria (R1 and R2) for the cells that fulfill the cell selection criteria S provided above. If the highest ranked cell is the serving cell, the UE may stay with the serving cell. Otherwise, if at least one neighbor cell is found to satisfy the reselection criteria, the UE may camp on the best cell selected. Otherwise, the UE may perform lower priority cell ranking and cell selection.

In the second step of performing cell selection or reselection, with respect to low priority inter-RAT or inter-frequency cell ranking and selection, the UE may select a neighboring cell that satisfies the S criteria as well as PL_{serving}≧PL_{serving,Low} and PL_{neighbor}≦PL_{X,Low}. If more than one cell that satisfies the conditions, then the UE may rank the cells based on PL and may select the cell that has the lowest PL. PL_{Serving,Low} may specify the PL threshold (in dB) used by the UE on the serving cell when reselecting towards a lower priority RAT or frequency. PL_{X,Low} may be the PL threshold (in dB) used by the UE when reselecting towards a lower priority RAT or frequency than the current serving frequency. If at least one neighbor cell is found to satisfy the reselection criteria, the UE may camp on the selected cell. Otherwise, the UE may perform the cell selection or reselection procedure as specified in release 8/9 for equal priority neighbor cells followed by the low priority neighbor cells.

If the UE does find any suitable neighboring cell satisfying the cell re-selection procedure as specified above with respect to higher priority inter-RAT or inter-frequency cell ranking and selection, equal priority inter-frequency or intra-frequency cell ranking and selection, or low priority inter-RAT or inter-frequency cell ranking selection, then the UE may continue to camp on the serving cell. Thus, in this case, the UE may not reselect a cell.

In another embodiment, the UE may perform higher priority inter-RAT or inter-frequency cell ranking and selection, or equal priority inter-frequency or intra-frequency cell ranking and selection, using the following procedure. First, the UE may rank the equal priority cells based on the revised R criteria (R1 and R2) for all the cells that fulfill the cell selection criteria S defined above. If the highest ranked cell is the serving cell, then UE may stay with the serving cell. Otherwise, if at least one equal priority neighbor cell is found to satisfy the reselection criteria, then UE may camp on the best cell selected. Otherwise, the UE may perform equal priority cell ranking based on the Rel. 8/9 cell selection or re-selection criteria. If UE does not find any equal priority cells satisfying the new cell re-selection criteria or the Rel. 8/9 cell re-selection criteria, then the UE may consider lower priority cells for cell selection. For selecting a lower priority cell on which to camp, the UE may use the new path loss based reselection metric. If no suitable neighbor cell is found on which to camp, the UE may fall back to the Rel. 8/9 cell reselection criteria defined for lower priority cells.

By using the S criteria, defined above, which includes a RSRQ for both a control channel and a data channel, the chances that a UE may fall into a coverage hole may be greatly reduced. However, coverage holes may still exist. One possible reason for the existence of remaining coverage holes could be inaccuracy of RSRQ measurements for a control channel or a data channel, as described above. This problem may exist in a homogenous network as well, but may be worse in a hetnet. The UE may camp on the selected cell. If a coverage hole is detected, the UE may redo cell selection by falling back to the Rel. 9 procedure.

As mentioned above, the coverage hole may occur for either a control channel or a data channel. In the IDLE state, there may be no active data connection. In this case, control channel coverage hole detection may be more important. A coverage hole could happen in the DL, the UL, or both. For example, if cell selection is based on DL best received power, a UL coverage hole is more likely to happen. If cell selection is based on PL, a DL coverage hole is more likely to happen. If cell selection is based on biased DL received power, both UL and DL coverage holes may occur, but not to the same UE. Either one will have a smaller chance to happen than in previous two cases.

For a UE to ascertain DL coverage, the UE may need to decode a MIB more than once. Note that MIB may be periodically transmitted by the access node over the BCCH. The UE may choose to detect BCCH MIB a number of times. A coverage hole may be detected if, for example, the UE fails to decode BCCH MIB a certain number times, m, out of n decode attempts, with m n. This detection technique may be used for DL coverage hole detection.

In order to detect an UL coverage hole, in another embodiment, immediately after the UE camps on a new cell, the UE can send a RACH message via contention based mode to the serving access node. Contention mode messaging is described with respect to FIGS. 2 and 3, below. In this case, the UE may expect to receive a RACH response from the access node. If the UE does not receive a valid response after a certain number of times, the UE may detect an UL coverage hole. The IDLE mode RACH procedure may be different from a CONNECTED mode RACH procedure.

FIG. 2 is an example flow for a contention based Random Access Procedure in Rel. 8/9, according to an embodiment of the present disclosure. This procedure may be implemented between a UE 200 and an access node 202. UE 200, access node 202, and the procedure shown in FIG. 2 may be implemented by hardware or software, such as the hardware and software described in FIG. 6. The UE 200 and access node 202 may be any of the UEs 118 and access nodes 106 described with respect to FIG. 1.

The process begins as the UE 200 transmits a random access preamble 204 to the access node 202. The access node 202 returns a random access response 206 to the UE 200. The UE then transmits a scheduled transmission 208 (i.e., message 3) to the access node 202. In response, the access node 202 transmits a contention resolution message 210 (i.e., message 4) to the UE 200. The process terminates thereafter.

FIG. 3 is an example flow for a contention based Random Access Procedure in Rel. 10 IDLE mode, according to an embodiment of the present disclosure. This procedure may be implemented between a UE 300 and an access node 302. UE 300, access node 302, and the procedure shown in FIG. 3 may be implemented by hardware or software, such as the hardware and software described in FIG. 6. The UE 300 and access node 302 may be any of the UEs 118 and access nodes 106 described with respect to FIG. 1.

The process begins as the UE 300 transmits to the access node 302 a RACH preamble 304. In response, the access node 302 transmits a RAR 306 to the UE 300. The UE 300 may check the validity of the RAR 308. The UE then may transmit another RACH preamble 310 to the access node 302. The access node may transmit a second RAR 312 to the UE 300, and the UE checks validity of the second RAR 314. This process may repeat, such as the UE 300 sending a third RACH preamble 316 to the access node 302, and the access node 302 sending a subsequent RAR 318 to the UE 300 and also the UE 300 checking the validity of the third RAR 320. Thus, in FIG. 3, a randomly selected RACH preamble may be sent on randomly selected RACH resources a number of times equal to some value, N.

In the procedure shown in FIG. 3, the UE may randomly select one of the RACH preambles from group A or group B based on the path loss requirements advertised by the newly selected access node. If a valid RAR 306 is received within the RAR window, the UE 300 may randomly select another RACH preamble and transmit the other RACH preamble to the access node 302 on a randomly selected RACH resource. This step may be used to ascertain that the RAR 306 is in response to the RACH preamble 304 sent by the UE 300. Note that if the RAR 306 is not received by the UE 300 within the time window, the UE 300 may send a randomly selected RACH preamble 304 with random back-off, but without increasing UE transmit power from the initial transmission.

This step may be used so that the increase in the probability of RACH collision may be alleviated to some extent. For example, if the UE selected the access node 302 based on path loss, the RACH procedure defined above may help ensure that both the UL and the DL have acceptable performance in case of a network attach procedure initiated by either the network or the UE. Note that the S criteria defined above may have a higher RSRQ requirement than any S criteria that may have been previously known. However, the S-criteria defined in conjunction with path loss based cell-selection may have a lower RSRQ requirement compared to the S-criteria defined in conjunction with a received power based cell reselection.

In yet another embodiment, a small number of RACH preambles may be reserved for IDLE mode UEs so that an IDLE mode RACH is less likely cause a collision with an active mode RACH. In another embodiment, only UEs that satisfy the following conditions may use an IDLE RACH:

If Squal_C≦threshold_C or Squal_D≦threshold_D, and the UE successfully decodes the BCCH, then the UE will perform RACH after cell selection. In this embodiment, threshold_C>q-QualMinC and threshold_D>q-QualMinD.

In another embodiment, a UE may not send any IDLE mode RACH. The UE may wait until there is a need to send TAU message in order to detect if there is an UL coverage hole. If the UE fails to establish the RRC/NAS connection for a TAU update, but the UE can still receive a paging message, then the UE may detect a UL coverage hole and redo cell selection. This procedure may help reduce RACH overhead.

Once a coverage hole is detected and the UE has camped on the serving cell for more than a particular time such as 1 second, the UE may redo cell selection. In an embodiment, the UE may fall back to the Rel. 9 cell ranking procedure, such as by performing cell ranking based on equation (2). Nevertheless, the S criteria may be still based on Rel. 10, if possible.

In order to avoid ping-ponging between two reselection procedures, and consequent ping-ponging between a low power cell (with a coverage hole) and a high power macro cell, care should be taken in selecting the criteria that allows the UE to tune back to the cell selection and reselection procedures, above, once the UE has recovered from a coverage hole. Recovery from a coverage hole may be claimed if, for example, the UE successfully decodes a MIB transmitted over the BCH, or a paging message, for a number, n, of consecutive times. Recovery might also be claimed if the measured RSRP/RSRQ of the serving cell exceeds a certain threshold over a certain period of time.

For example, in an embodiment, assume T1 seconds have elapsed after the coverage hole has been recovered, and also that T2 seconds have elapsed after the UE has camped on the current serving cell. In this case, the UE may revert back to the R10 cell selection criteria. In this case, both T1 and T2 may be greater than 1 second. This example is non-limiting, and the exact values provided above may vary depending on implementation.

With the above embodiments, even though interference coordination may not be performed effectively (either on the control channel or on the data channel), and even though the RSRP and RSRQ may not be estimated correctly (especially at the cell edge), the hybrid cell selection procedures defined above may still prevent UEs from falling into a coverage hole and further may allow UEs to quickly recover from a coverage hole. The embodiments described above might not be applicable for Rel. 8/9 UEs. The embodiments described above may apply to LTE-A or LTE-A beyond UEs only.

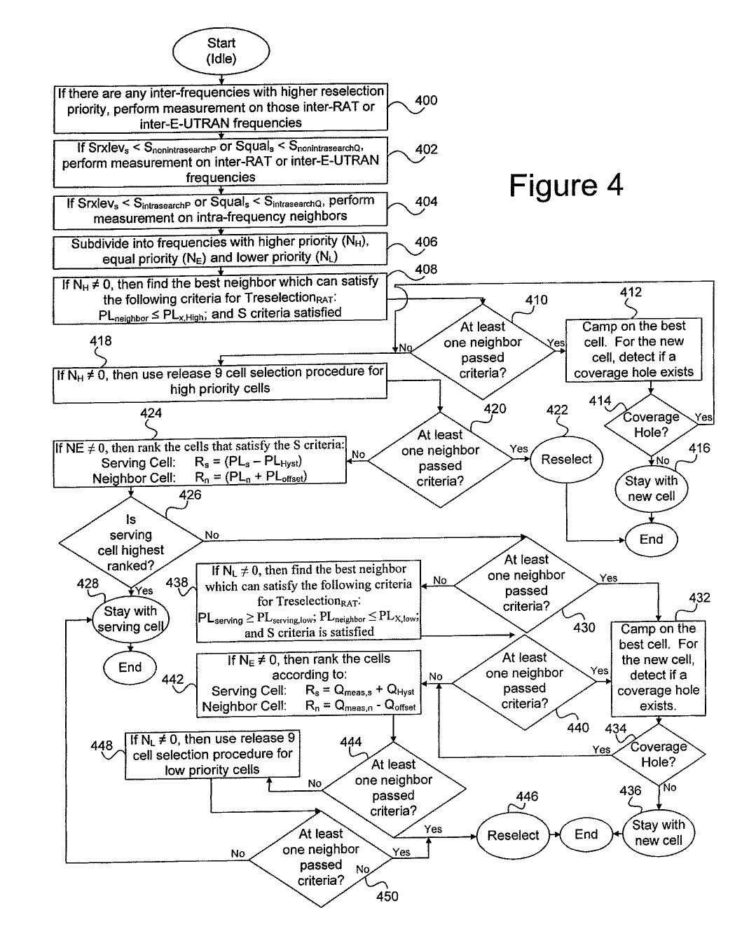

FIG. 4 is an example cell selection procedure for use in a heterogeneous network, according to an embodiment of the present disclosure. FIG. 4 shows one example how some of the embodiments described herein may be included into a complete process for inter-RAT, inter-frequency, and intra-cell selection and reselection. The process shown in FIG. 4 may be implemented in a heterogeneous network, such as shown in FIG. 1, using access nodes and UEs as described in FIG. 1. The process shown in FIG. 4 may be implemented using hardware or software, such as shown in FIG. 6. The process shown in FIG. 4 may be performed by a UE.

The process starts from an IDLE state. If there are any inter-frequencies with a higher reselection priority, the UE may perform a measurement on those inter-RAT or inter-E-UTRAN frequencies (block 400). If Srxlevₛ<S_{nonintrasearchP} or if Squalₛ<S_{nonintrasearchQ}, then the UE may perform measurements on inter-RAT or inter-E-UTRAN frequencies (block 402). If Srxlevₛ<S_{intrasearchP} or Squalₛ<S_{intrasearchQ}, then the UE may perform measurements on intra-frequency neighbors (block 404). The UE then may subdivide measured frequencies into frequencies with higher priority (N_{H}), equal priority (N_{E}), and lower priority (N_{L}) (block 406). Note that all of the inter-RAT neighbor cells may have either a higher or lower reselection priority than the serving cell.

If N_{H}≠0, then the UE may find the best neighbor which can satisfy the following criteria for Treselection_{RAT}: PL_{neighbor}≦PL_{X,High} and S (block 408). The UE may then determine whether at least one neighbor has passed the criteria (block 410). If the criteria is passed (a “yes” determination at block 410), the UE may camp on the best cell, and the UE may detect if a coverage hole exists for this new cell (block 412). After camping, the UE determines whether there is a coverage hole (block 414). If a coverage hole doe not exist, then the UE may stay with a new cell (block 416) and the process terminates thereafter.

However, if the determines that a coverage hole exists (a “yes” at block 414) or if no neighbor has passed criteria (a “no” determination at block 410), then if N_{H}≠0, the UE may use release 9 cell selection procedures for high priority cells (block 418). The UE again determines whether at least one neighbor has passed the criteria (block 420). If at least one neighbor cell passes the criteria, then the UE may perform a reselection procedure (block 422), and the process the process terminates thereafter. If no neighbor has passed the criteria (a “no” determination at block 420), then, if NE≠0, the UE may then rank the cells that satisfy the S criteria, wherein the rank for the serving cell may be determined according to Rₛ=(PLₛ−PL_{hyst}) and the rank for the neighbor cell may be determined according to Rₙ=(PLₙ+PL_{offset}) (block 424).

The UE then determines if the serving cell is the highest ranked cell (block 426). If the serving cell is the highest ranked (a “yes” determination at block 426), then the UE may stay with the serving cell (block 428), and the process terminates thereafter. However, if the serving cell is not the highest ranked (a “no” determination at block 426), then the UE may determine, again, whether at least one neighbor has passed the criteria (block 430). If at least one neighbor has passed the criteria, (a “yes” determination at block 430), then the UE may camp on the best cell and may detect if a coverage hole exists for this new cell (block 432). Thereafter the UE may determine if a coverage hole exists (block 434). If the UE determines no coverage hole exists, (a “no” determination at block 434), the UE may stay with the new cell (block 436), and the process terminates thereafter. However, if a coverage hole is found (a “yes” determination at block 434), then the UE proceeds to the process at block 442, as further provided below.

Returning to block 430, if the UE determines that at least one neighbor cell has not passed the criteria (a “no” determination at block 430), and if N_{L}≠0, then the UE finds the best neighbor cell which can satisfy the following criteria for Treselection_{RAT}: PL_{serving}≧PL_{serving,low}; PL_{neighbor}≦PL_{X,iow}; and S (block 438). The UE then determines again whether at least one neighbor cell has passed the criteria (block 440). If the UE determines that at least one neighbor has passed the criteria (a “yes” determination at block 440), then the process returns to block 432 and proceeds accordingly. If the UE determines that no neighbor cell has passed the criteria (a “no” determination at block 440), then, if N_{E}≠0, the UE may rank the cells according to the following parameters: for the serving cell, Rₛ=Q_{meas,s}+Q_{Hyst} and for the neighbor cell Rₙ=Q_{meas,n}−Q_{offset} (block 442). This ranking at block 442 may also take place after a determination that a coverage hole exists (a “yes” determination at block 434).

The UE then makes another determination whether at least one neighbor cell has passed the criteria (block 444). If at least one neighbor cell has passed the criteria (a “yes” determination at block 444), then the UE may perform reselection (block 446), and the process terminates thereafter. If at least one neighbor cell has not passed the criteria (a “no” determination at block 444), then, if N_{L}≠0, the UE may use the release 9 cell selection procedure for low priority cells (block 448).

Again, the UE may determine whether at least one neighbor cell has passed the criteria (block 450). If at least one neighbor cell has passed the criteria (a “yes” determination at block 450), then the UE may perform reselection (block 446) and the process terminates thereafter. Otherwise, if at least one neighbor cell has not passed the criteria (a “no” determination at block 450), the UE may stay with the serving cell (block 428) and the process terminates thereafter.

In the exemplary procedure described with respect to FIG. 4, blocks 400, 402, 404, 406, and 408 reflect measurements and analysis performed by the UE. Blocks 418, 442, 444, 448, and 450 reflect reselection techniques that may use Rel. 9 reselection procedures. Blocks 408, 410, 412, 414, 416, 420, 422, 424, 426, 428, 430, 432, 434, 436, 438, and 440 are procedures that may be added to Rel. 9 reselection procedures, or that may be used in addition or instead of Rel. 9 reselection procedures.

Primary Cell Selection Based on Biased Range Expansion

The embodiments described above relate to primary cell selection using path loss based range expansion. Another set of embodiments is now presented relating to primary cell selection based on biased range expansion.

In this set of embodiments, when a UE performs cell selection, it may consider applying an offset directly to the measured RSRP value. The offset can be broadcasted via the system information. The same S criteria defined above in equation (6) may be applied the embodiments relating to biased range expansion. However, a different R (ranking) criterion may be used.

R Criteria Definition

In one embodiment, the R criteria may be defined as follows, which may be referred to as R1 for biased range expansion. The cell with the largest R criteria may be selected.

Rₛ=Q_{meas,s}+Q_{Hyst}+Qoffset1_{—s}

Rₙ=Q_{meas,n}+Qoffset1ₙ−Qoffset (9)

| | | |
|---|---|---|
| Qₘₑₐₛ | is | RSRP measurement quantity used in cell reselections. |
| Ooffset1_s | is | RSRP offset value as defined in equation (5), i.e, |
| | | Qoffset1 = RSRP bias. This value may be cell |
| | | specific. |
| Qoffset | is | For intra-frequency: Equals to Qoffset_{s,n}, if |
| | | Qoffset_{s,n} is valid, otherwise this equals to zero. |
| | | For inter-frequency: Equals to Qoffset_{s,n} plus |
| | | Qoffset_{frequency}, if Qoffset_{s,n} is valid, |
| | | otherwise this equals to Qoffset_{frequency}. |
| Q_Hyst | is | Specifies the hysteresis value for ranking criteria, |
| | | broadcast in serving cell system information |
| Q_{meas,s} | is | Reference Signal Received Power measurement |
| | | quantity in the serving cell used in cell reselections. |
| Q_{meas,n} | is | Reference Signal Received Power measurement |
| | | quantity in the neighbouring cell used in cell selection |
| | | or reselection. |

In equation (9), different cells may have different Qoffset1 values. One of the factors that impact the value of Qoffset1 is the access node transmission power. Qoffset may be defined in Rel. 8/9 and broadcast in a SIB4 message. A new field Qoffset1 may be added in a SIB2->radioResourceConfigCommonSIB->pdsch-ConfigCommon message for the serving cell and in SIB4 and SIB5 for the neighboring cells. An example of such a SIB2 message with a specified Qoffset1 is provided below, with changes in italics:

-- ASN1START

| | |
|---|---|
| PDSCH-ConfigCommon ::= | SEQUENCE { |

| | |
|---|---|
| referenceSignalPower | INTEGER (−60..50), |
| q-OffsetCell1 | Q-OffsetRange1 OPTIONAL, -- Cond Hetnet |
| p-b | INTEGER (0..3) |

}

| | | |
|---|---|---|
| PDSCH-ConfigDedicated::= | SEQUENCE | { |

| | |
|---|---|
| p-a | ENUMERATED { |

dB-6, dB-4dot77, dB-3, dB-1dot77,
dB0, dB1, dB2, dB3}

}
-- ASN1STOP

Qoffset1 may also be specified in other SIB messages. The following is an example of a Qoffset1 being specified in a SIB4 message for intra-frequency neighboring cells, with changes in italics.

-- ASN1START

| | |
|---|---|
| SystemInformationBlockType4 ::= | SEQUENCE { |

| | | | |
|---|---|---|---|
| intraFreqNeighCellList | IntraFreqNeighCellList | OPTIONAL, | -- Need OR |

| | | | |
|---|---|---|---|
| intraFreqBlackCellList | IntraFreqBlackCellList | OPTIONAL, | -- Need |

OR

| | | | |
|---|---|---|---|
| csg-PhysCellIdRange | PhysCellIdRange | OPTIONAL, | -- Cond CSG |

...

}

| | |
|---|---|
| IntraFreqNeighCellList ::= | SEQUENCE (SIZE (1.. maxCellIntra)) OF IntraFreqNeighCellInfo |
| IntraFreqNeighCellInfo ::= | SEQUENCE { |

| | |
|---|---|
| physCellId | PhysCellId, |
| q-OffsetCell | Q-OffsetRange |
| q-OffsetCell1 | Q-OffsetRange1 OPTIONAL, -- Cond Hetnet |

...

}

| | |
|---|---|
| IntraFreqBlackCellList ::= | SEQUENCE (SIZE (1.. maxCellBlack)) OF PhysCellIdRange |

-- ASN1STOP

The following is an example of a Qoffset1 being specified in a SIB5 message for inter-frequency neighboring cells, with changes in italics.

-- ASN1START

| | |
|---|---|
| SystemInformationBlockType5 ::= | SEQUENCE { |

| | |
|---|---|
| interFreqCarrierFreqList | InterFreqCarrierFreqList, |

| ..., | | | |
|---|---|---|---|
| lateR8NonCriticalExtension | OCTET STRING | OPTIONAL | -- Need OP |

}

| | |
|---|---|
| InterFreqCarrierFreqList ::= | SEQUENCE (SIZE (1.. maxFreq)) OF InterFreqCarrierFreqInfo |

| | |
|---|---|
| InterFreqCarrierFreqInfo ::= | SEQUENCE { |

...,

}

| | |
|---|---|
| InterFreqNeighCellList ::= | SEQUENCE (SIZE (1.. maxCellInter)) OF InterFreqNeighCellInfo |
| InterFreqNeighCellInfo ::= | SEQUENCE { |

| | |
|---|---|
| physCellId | PhysCellId, |
| q-OffsetCell | Q-OffsetRange |
| q-offsetCell1 | Q-offsetRange1, OPTIONAL -- Cond Hetnet |

}

| | |
|---|---|
| InterFreqBlackCellList ::= | SEQUENCE (SIZE (1.. maxCellBlack)) OF PhysCellIdRange |

-- ASN1STOP

In another embodiment, R criteria similar to that defined for path loss based range expansion may also be used here. These R criteria may be referred to as R2 for the embodiments relating to biased range expansion. In an embodiment, the cell with the largest R criteria shall be selected.

The access node may configure the appropriate Qoffset1 value in equation 8 to achieve the goal of equation 10, below. These two different embodiments are presented because the information to be exchanged among access nodes may be different. Qoffset1 in equation (10) may represent bias_s−bias_n, while Qoffset 1 may represent ReferenceSiganlPower_n−ReferenceSignalPower_s in equation (8). Thus, the range and meaning of Qoffset1 in the two equations may be different.

Rₛ=Q_{meas,s}+Q_{Hyst}

Rₙ=Q_{meas,n}−Qoffset1_{—n}−Qoffset (10)

### Where:

| | | |
|---|---|---|
| Qₘₑₐₛ | is | RSRP measurement quantity used in cell reselections. |
| Qoffset1_n | is | Defined as the reference of RSRP bias between two |
| | | cells s,n, i.e, bias_s − bias_n. This value is |
| | | cell specific. |
| Qoffset | is | For intra-frequency: Equals to Qoffset_{s,n}, if Qoffset_{s,n} |
| | | is valid, otherwise this equals to zero. |
| | | For inter-frequency: Equals to Qoffset_{s,n} plus |
| | | Qoffset_{frequency}, if Qoffset_{s,n} is valid, |
| | | otherwise this equals to Qoffset_{frequency}. |
| Q_Hyst | is | Specifies the hysteresis value for ranking criteria, |
| | | broadcast in serving cell system information |
| Q_{meas,s} | is | Reference Signal Received Power measurement |
| | | quantity in the serving cell used in cell |
| | | reselections. |
| Q_{meas,n} | is | Reference Signal Received Power measurement |
| | | quantity in the neighbouring cell used in cell |
| | | selection or reselection. |

The same field for Qoffset1 may be added into SIB4 and SIB5 messages, as shown above with respect to the new SIB4 message for intra-frequency neighboring cells and the new SIB5 message for inter-frequency neighboring cells for R2. Similarly, multiple alternatives exist to reduce the SIB4 and SIB5 message sizes, as well as for reducing backhaul traffic exchanging the RSRP offset information among access nodes. These alternatives are similar to those described with respect to primary cell selection based on path loss based range expansion, above, though these alternatives are also addressed below.

In a first alternative, which may only apply to R1, each access node may only transmit its own q-OffsetCell1 in a SIB2 message. In this case, the UE may use its previously stored q-OffsetCell1 for each corresponding cell when calculating Rₛ and Rₙ, above. If no previously stored q-OffsetCell1 exists for a cell, then the UE may assume 0 for a conservative cell selection.

In a second alternative for reducing SIB message sizes, which may apply to both R1 and R2, each cell (macro or micro) may establish a partial list of q-OffsetCell1 values. The partial list may then be transmitted via the SIB4 and SIB5 messages. When the UE receives the partial list, the UE may apply the revised cell ranking formula when performing the cell-reselection ranking procedure.

If q-OffsetCell1 of the cell is not included in the partial list, a default value may be used. The default value for q-OffsetCell1 in R1 may be zero. The default value for q-OffsetCell1 may be as follows for R2.

In this alternative, the UE may have to differentiate a macro access node and a micro/pico/femto/relay access node. One possible way to perform this differentiation is through access node PCI. The access node PCI may be divided into different ranges so that each range corresponds to one type of access node. Thus, the UE may be able to derive different settings of the various parameters (q-offsetcell1, as well as the access node reference power) from the PCI range. In this case, there is no need to broadcast the neighboring access node reference power, as this parameter could be derived from the neighboring access node PCI.

In another alternative, each cell (macro or micro) may advertise the transmit power classification of the neighboring access node (macro, micro, pico) over a SIB4 or SIB5 message. A default power difference value may be assumed by the UE in calculating the PL. For example, if the serving access node is a macro access node, the UE may assume that a default transmit power difference, such as but not limited to 15 dB, may exist between the serving access node and the neighboring access node. If the serving access node is a micro-access node, then the default power difference may have a different value, such as but not limited to zero. This technique might be undesirably conservative if the neighboring cell is a macro-access node. However, this technique may prevent the risk of a UE to mistakenly treating a neighboring micro-access node as a macro-access node.

Once the UE camps on the selected cell, the will have the proper power information for the serving cell. Thus, the subsequent time the UE comes back, the selection may be more accurate.

In a third alternative for reducing SIB message sizes, instead of broadcasting the q-OffsetCell1 for the serving cell and the neighboring cell, a single bit indicator of whether the access node is a high power or low power access node may be signaled. A default value of power difference between the high power node and low power access node, such as but not limited to 15 dB, may be assumed at the UE. Thus, the signaling overhead may be much reduced, while the UE may still be able to perform cell selection or reselection while considering access node transmission power. This single bit indicator of the serving cell may be added to a SIB2 message, and the single bit indicator for the neighboring cells may be added to SIB4 or SIB5 messages for the neighboring cells. The UE may calculate Qoffset1 by itself. This scheme may be extended to a multi-bit solution if multiple-level transmission powers exist in the network for different nodes. For example, two bits can handle four different levels of pre-defined transmission powers.

In a fourth alternative for reducing SIB message sizes, in some cases the access node power levels may be limited to a few classes, such as but not limited to 46 dBm, 37 dBm, and 30 dBm. In this case, two bits may be enough to indicate the access node power class. Thus, the power class of the serving cell may be broadcast in a SIB2 message, and the power classes of the neighboring cells may be broadcast in a SIB4 or SIB5 message. The UE may calculate Qoffset1 by itself. The indicator mapping may be standardized or signaled to the UEs via high layer signaling, such as the BCCH.

Cell Selection and Reselection

The same cell selection and reselection procedures described with respect to path loss based range expansion, above, may be applied to biased range expansion. However, in an embodiment, one difference between the two techniques may be in the cell ranking for equal priority cells, as provided above.

### CONCLUSIONS

When the UE performs a mobility procedure, the UE desirably may choose the best cell. The best cell may normally be the cell with the best signal strength. However, in a heterogeneous network, cell selection based only on signal strength may lead to inefficient channel utilization and high UE power consumption. Range expansion and load balancing based cell selection, as provided herein, may effectively increase the coverage area of low power access nodes and increase resource utilization. Nevertheless, UEs may still fall into a poor SINR region due to improper cell selection. The embodiments described herein provide for a hybrid cell selection scheme that can either prevent or recover from falling into a coverage hole. The schemes described herein may effectively reduce the chances of the UE being served in an undesirable geometry area.

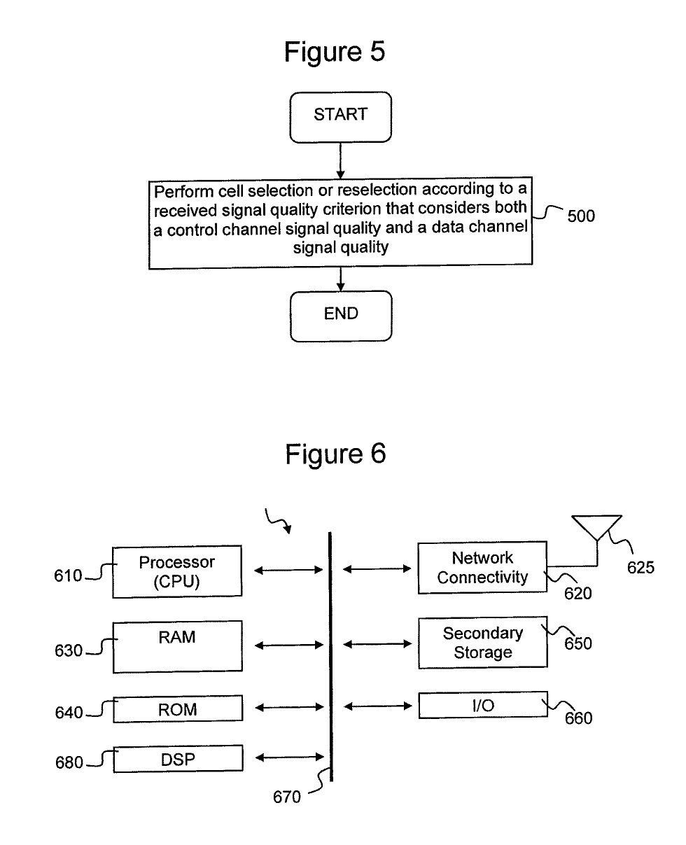

FIG. 5 is an example cell selection procedure for use in a heterogeneous network, according to an embodiment of the present disclosure. This procedure may be implemented in a UE using hardware or software, such as the hardware and software described in FIG. 6. The UE may be any of the UEs 118 described with respect to FIG. 1. The UE performs cell selection or reselection according to a received signal quality criterion that considers both a control channel signal quality and a data channel signal quality (block 500). The process terminates thereafter. The values of S and R, described above with respect to FIGS. 1-4, may be determined according to the formulas and procedures described above. The range expansion technique may be either path loss based range expansion or biased range expansion, also as described above.

The UE and other components described above might include processing and other components that alone or in combination are capable of executing instructions or otherwise able to promote the occurrence of the actions described above. FIG. 6 illustrates an example of a system 600 that includes a processing component, such as processor 610, suitable for implementing one or more embodiments disclosed herein. Accordingly, system 600 may be employed to execute one or more of the previously-described entities such as the Ad Server, the Ad Engine, the Ad App, the DM Server, the DM Client, the XDMC and the XDMS. In addition to the processor 610 (which may be referred to as a central processor unit or CPU), the system 600 might include network connectivity devices 620, random access memory (RAM) 630, read only memory (ROM) 640, secondary storage 650, and input/output (I/O) devices 660. These components might communicate with one another via a bus 670. In some cases, some of these components may not be present or may be combined in various combinations with one another or with other components not shown. These components might be located in a single physical entity or in more than one physical entity. Any actions described herein as being taken by the processor 610 might be taken by the processor 610 alone or by the processor 610 in conjunction with one or more components shown or not shown in the drawing, such as a digital signal processor (DSP) 680. Although the DSP 680 is shown as a separate component, the DSP 680 might be incorporated into the processor 610.

The processor 610 executes instructions, codes, computer programs, or scripts that it might access from the network connectivity devices 620, RAM 630, ROM 640, or secondary storage 650 (which might include various disk-based systems such as hard disk, floppy disk, or optical disk). While only one CPU 610 is shown, multiple processors may be present. Thus, while instructions may be discussed as being executed by a processor, the instructions may be executed simultaneously, serially, or otherwise by one or multiple processors. The processor 610 may be implemented as one or more CPU chips.

The network connectivity devices 620 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 620 may enable the processor 610 to communicate with the Internet or one or more telecommunications networks or other networks from which the processor 610 might receive information or to which the processor 610 might output information. The network connectivity devices 620 might also include one or more transceiver components 625 capable of transmitting and/or receiving data wirelessly.

The RAM 630 might be used to store volatile data and perhaps to store instructions that are executed by the processor 610. The ROM 640 is a non-volatile memory device that typically has a smaller memory capacity than the memory capacity of the secondary storage 650. ROM 640 might be used to store instructions and perhaps data that are read during execution of the instructions. Access to both RAM 630 and ROM 640 is typically faster than to secondary storage 650. The secondary storage 650 is typically comprised of one or more disk drives or tape drives and might be used for non-volatile storage of data or as an over-flow data storage device if RAM 630 is not large enough to hold all working data. Secondary storage 650 may be used to store programs that are loaded into RAM 630 when such programs are selected for execution.

The I/O devices 660 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 625 might be considered to be a component of the I/O devices 660 instead of or in addition to being a component of the network connectivity devices 620.

Thus, the embodiments provide for a method and UE comprising a processor configured to perform cell selection or reselection according to a received signal quality criterion that considers both a control channel signal quality and a data channel signal quality. In an embodiment, the processor is further configured to perform the cell selection or reselection according to a cell ranking criterion. In an embodiment, the processor is further configured to perform the cell selection or reselection to one of a low power access node, a pico access node, and a femto access node.

In an embodiment, the received signal quality criterion further comprises a path loss based metric. In an embodiment, path loss is defined by a reference signal transmit power level minus a higher layered filtered reference signal received power. In an embodiment, wherein the cell selection or reselection criterion fulfills the criteria defined as Srxlev>0 AND Squal_D>0 AND Squal_C>0, wherein

Srxlev=Qᵣₓₗₑᵥₘₑₐₛ−(Qᵣₓₗₑᵥₘᵢₙ+Q_{rxlevminoffset})−Pcompensation

Squal_{—}D=Q_{qualmeasD}−(Q_{qualminD}+Q_{qualminoffsetD})

Squal_{—}C=Q_{qualmeasC}−(Q_{qualminC}+Q_{qualminoffsetC})

and

| | | |
|---|---|---|
| Srxlev | is | Cell selection reception power level value (decibels) |
| Squal_D | is | Cell selection quality value (decibels) for a data |
| | | channel |
| Squal_C | is | Cell selection quality value (decibels) for a control |
| | | channel |
| Qᵣₓₗₑᵥₘₑₐₛ | is | Measured cell reception power level value |
| | | (Reference Signal Received Power) |
| Q_{qualmeasD} | is | Measured cell quality value (Reference Signal |
| | | Received Quality) for a data channel |
| Q_{qualmeasC} | is | Measured cell quality value (Reference Signal |
| | | Received Quality) for a control channel |
| Qᵣₓₗₑᵥₘᵢₙ | is | Minimum required reception power level in the cell |
| | | (decibels) |
| Q_{qualminD} | is | Minimum required quality level in the cell (decibels) |
| | | for data channel |
| Q_{qualminC} | is | Minimum required quality level in the cell (decibels) |
| | | for a control channel |
| Q_{rxlevminoffset} | is | Offset to the signaled Qᵣₓₗₑᵥₘᵢₙ taken into account |
| | | in the Srxlev evaluation as a result of a periodic |
| | | search for a higher priority public land |
| | | mobile network while camped normally |
| | | in a visited public land mobile network |
| Q_{qualminoffsetD} | is | Offset to the signalled Q_{qualmin}D taken into account |
| | | in the Squal_D evaluation as a result of a periodic |
| | | search for a higher priority public land mobile |
| | | network while camped normally in a visited public |
| | | land mobile network |
| Q_{qualminoffsetC} | is | Offset to the signalled Q_{qualmin}C taken into account |
| | | in the Squal_C evaluation as a result of a periodic |
| | | search for a higher priority public land mobile |
| | | network while camped normally in a visited public |
| | | land mobile network |
| Pcompensation | is | max(P_{EMAX}_{_{—}}_{H} − P_{PowerClass}, 0) (decibels) |
| P_{EMAX}_{_{—}}_{H} | is | Maximum transmission power level a user |
| | | equipment uses when transmitting on the uplink in |
| | | the cell (decibels) defined as P_{EMAX}_{_{—}}_{H} in [technical |
| | | specification 36.101] |
| P_{PowerClass} | is | Maximum radio frequency output power of the user |
| | | equipment (decibels) according to the user |
| | | equipment power class as defined in [technical |
| | | specification 36.101] |

In an embodiment, the cell ranking criterion comprises an Rs for a serving cell and an Rn for neighboring cells, and wherein the cell ranking criterion is defined as one of:

Rₛ=PL_{meas,s}+Q_{Hyst—}PL

Rₙ=PL_{meas,n}−Qoffset_PL (2)

or

Rₛ=Q_{meas,s}+Q_{Hyst}

Rₙ=Q_{meas,n}−Qoffset1−Qoffset (8)

### Where:

| | | |
|---|---|---|
| PLmeas,s | is | Pathloss measurement quantity in the serving cell used in |
| | | cell selection or reselection. |
| PLmeas,n | is | Pathloss measurement quantity in neighbouring cell used in cell |
| | | reselections. |
| QHyst_PL | is | The hysteresis value for ranking criteria, broadcast in |
| | | serving cell system information |
| Qoffset_PL | is | For intra-frequency: Equals to Qoffset_pls, n, if Qoffset_pls, n is |
| | | valid, otherwise this equals to zero. |
| | | For inter-frequency: Equals to Qoffset_pls, n plus |
| | | Qoffsetfrequency, if Qoffsets, n is valid, otherwise this equals |
| | | to Qoffsetfrequency. |
| Q_{meas,s} | is | Reference Signal Received Power measurement quantity in |
| | | the serving cell used in cell reselections. |
| Q_{meas,n} | is | Reference Signal Received Power measurement quantity in |
| | | the neighbouring cell used in cell selection or reselection. |
| Qoffset1 | is | Defined as the reference signal power difference between |
| | | two cells n, s, that is, ReferenceSiganlPower_n − |
| | | ReferenceSignalPower_s. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, |
| | | if Qoffset_{s,n} is valid, otherwise this equals to Qoffset_{frequency}. |
| Q_Hyst | is | Specifies the hysteresis value for ranking criteria, broadcast |
| | | in serving cell system information |

In an embodiment, Qoffset1 and Qoffset are used in equation 8 when the UE experiences a certain channel quality condition while Qoffset1 is omitted when the UE experiences another channel quality condition. In an embodiment, the certain channel quality condition comprises when the channel quality received at the UE is above a threshold. In an embodiment, the another channel quality condition comprises when the channel quality received at the UE is below a threshold. In an embodiment, the certain channel quality condition comprises when the UE succeeds in decoding at least one of a control channel and a data channel with a given packet loss rate. In an embodiment, the another channel quality condition comprises when the UE fails to decode at least one of control channel and data channel with a given packet loss rate.

In an embodiment, the cell selection or reselection criteria comprises a biased path loss metric. In an embodiment, the cell selection or reselection criterion fulfills the criteria defined as Srxlev>0 AND Squal_D>0 AND Squal_C>0, wherein

Srxlev=Qᵣₓₗₑᵥₘₑₐₛ−(Qᵣₓₗₑᵥₘᵢₙ+Q_{rxlevminoffset})−Pcompensation

Squal_{—}D=Q_{qualmeasD}−(Q_{qualminD}+Q_{qualminoffsetD})

Squal_{—}C=Q_{qualmeasC}−(Q_{qualminC}+Q_{qualminoffsetC}) and

| | | |
|---|---|---|
| Srxlev | is | Cell selection reception power level value (decibels) |
| Squal_D | is | Cell selection quality value (decibels) for a data |
| | | channel. |
| Squal_C | is | Cell selection quality value (decibels) for a control |
| | | channel. |
| Qᵣₓₗₑᵥₘₑₐₛ | is | Measured cell reception power level value |
| | | (Reference Signal Received Power) |
| Q_{qualmeasD} | is | Measured cell quality value (Reference Signal |
| | | Received Quality) for a data channel |
| Q_{qualmeasC} | is | Measured cell quality value (Reference Signal |
| | | Received Quality) for a control channel |
| Qᵣₓₗₑᵥₘᵢₙ | is | Minimum required reception power level in the cell |
| | | (decibels) |
| Q_{qualminD} | is | Minimum required quality level in the cell (decibels) |
| | | for data control |
| Q_{qualminC} | is | Minimum required quality level in the cell (decibels) |
| | | for a control channel |
| Q_{rxlevminoffset} | is | Offset to the signaled Qᵣₓₗₑᵥₘᵢₙ taken into account in |
| | | the Srxlev evaluation as a result of a periodic search |
| | | for a higher priority public land mobile network |
| | | while camped normally in a visited public |
| | | land mobile network |
| Q_{qualminoffsetD} | is | Offset to the signalled Q_{qualmin}D taken into account |
| | | in the Squal_D evaluation as a result of a periodic |
| | | search for a higher priority public land mobile |
| | | network while camped normally in a visited public |
| | | land mobile network |
| Q_{qualminoffsetC} | is | Offset to the signalled Q_{qualmin}C taken into account |
| | | in the Squal_C evaluation as a result of a periodic |
| | | search for a higher priority public land mobile |
| | | network while camped normally in a visited public |
| | | land mobile network |
| Pcompensation | is | max(P_{EMAX}_{_{—}}_{H} − P_{PowerClass}, 0) (decibels) |
| P_{EMAX}_{_{—}}_{H} | is | Maximum transmission power level a user |
| | | equipment uses when transmitting on the uplink in |
| | | the cell (decibels) defined as P_{EMAX}_{_{—}}_{H} in [technical |
| | | specification 36.101] |
| P_{PowerClass} | is | Maximum radio frequency output power of the user |
| | | equipment (decibels) according to the user |
| | | equipment power class as defined in [technical |
| | | specification 36.101] |

In an embodiment, the cell ranking criterion comprises an Rs for a serving cell and an Rn for neighboring cells, and wherein the cell ranking criterion is defined as one of:

Rₛ=Q_{meas,s}+Q_{Hyst}+Qoffset1_{—s}

Rₙ=Q_{meas,n}+Qoffset1ₙ−Qoffset (9)

### Where:

| | | |
|---|---|---|
| Q_{meas,s} | is | Reference Signal Received Power measurement quantity in the |
| | | serving cell s used in cell reselections. |
| Q_{meas,n} | is | Reference Signal Received Power measurement quantity in the |
| | | neighboring cell n used in cell reselections. |
| Ooffset1_s | is | Reference Signal Received Power offset value, i.e, Qoffset1_s = |
| | | Reference Signal Received Power bias for the serving cell. |
| Qoffset1_n | is | Reference Signal Received Power offset value, i.e, Qoffset1_n = |
| | | Reference Signal Received Power bias for the neighbouring cell. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, if |
| | | Qoffset_{s,n} is valid, otherwise this equals to Qoffset_{frequency}. |
| Q_Hyst | is | Specifies the hysteresis value for ranking criteria, broadcast in |
| | | serving cell system information |

or

Rₛ=Q_{meas,s}+Q_{Hyst}

Rₙ=Q_{meas,n}−Qoffset1_{—n}−Qoffset (10)

### Where:

| | | |
|---|---|---|
| Q_{meas,s} | is | Reference Signal Received Power measurement quantity in the |
| | | serving cell s used in cell reselections. |
| Q_{meas,n} | is | Reference Signal Received Power measurement quantity in the |
| | | neighbouring cell n used in cell reselections. |
| Qoffset1_n | is | Defined as the reference of Reference Signal Received Power bias |
| | | between two cells s, n, i.e, bias_s − bias_n. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, if |
| | | Qoffset_{s,n} is valid, otherwise this equals to Qoffset_{frequency}. |
| Q_Hyst | is | Specifies the hysteresis value for ranking criteria, broadcast in |
| | | serving cell system information |

In an embodiment, Qoffset1n together with Qoffset are used by the UE to use path loss based cell selection or reselection when a coverage hole is not detected, and where Qoffset is used by the UE to use best power based cell selection or reselection as a fall back mechanism when a coverage hole is detected. In an embodiment, the coverage hole is detected when a packet error rate over a downlink transmission or an uplink transmission is above a predetermined packet error rate, and wherein the coverage hole is also detected when a received signal quality over the downlink transmission or the uplink transmission is above a predetermined received signal quality. In an embodiment, detection of the coverage hole is checked by measuring a success rate or failure rate over one or more downlink or uplink control channels. In an embodiment, the one or more downlink or uplink control channels are configured to assist detection of the coverage hole.

In an embodiment, Qoffset1_n and Qoffset are used in Rn criteria (10) when the UE experiences a certain channel quality condition while Qoffset1 is omitted when the UE experiences another channel quality condition. In an embodiment, the certain channel quality condition comprises when the channel quality received at the UE is above a threshold. In an embodiment, the another channel quality condition comprises when the channel quality received at the UE is below a threshold. In an embodiment, the certain channel quality condition comprises when the UE succeeds in decoding at least one of a control channel and a data channel with a given packet loss rate. In an embodiment, the another channel quality condition comprises when the UE fails to decode at least one of a control channel and a data channel with a given packet loss rate.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A UE comprising:
a processor configured to perform cell selection or reselection according to a received signal quality criterion that considers both a control channel signal quality and a data channel signal quality.

2. The UE of claim 1 wherein the processor is further configured to perform the cell selection or reselection according to a cell ranking criterion.

3. The UE of claim 1 wherein the processor is further configured to perform the cell selection or reselection to one of a low power access node, a pico access node, and a femto access node.

4. The UE of claim 1 wherein the received signal quality criterion further comprises a path loss based metric.

5. The UE of claim 4 wherein path loss is defined by a reference signal transmit power level minus a higher layered filtered reference signal received power.

6. The UE of claim 4 wherein the cell selection or reselection criterion fulfills the criteria defined as Srxlev>0 AND Squal_D>0 AND Squal_C>0, wherein
Srxlev=Qᵣₓₗₑᵥₘₑₐₛ−(Qᵣₓₗₑᵥₘᵢₙ+Q_{rxlevminoffset})−Pcompensation
Squal_{—}D=Q_{qualmeasD}−(Q_{qualminD}+Q_{qualminoffsetD})
Squal_{—}C=Q_{qualmeasC}−(Q_{qualminC}+Q_{qualminoffsetC})
and

| | | |
|---|---|---|
| Srxlev | is | Cell selection reception power level value (decibels) |
| Squal_D | is | Cell selection quality value (decibels) for a data |
| | | channel |
| Squal_C | is | Cell selection quality value (decibels) for a control |
| | | channel |
| Qᵣₓₗₑᵥₘₑₐₛ | is | Measured cell reception power level value |
| | | (Reference Signal Received Power) |
| Q_{qualmeasD} | is | Measured cell quality value (Reference Signal |
| | | Received Quality) for a data channel |
| Q_{qualmeasC} | is | Measured cell quality value (Reference Signal |
| | | Received Quality) for a control channel |
| Qᵣₓₗₑᵥₘᵢₙ | is | Minimum required reception power level in the cell |
| | | (decibels) |
| Q_{qualminD} | is | Minimum required quality level in the cell (decibels) |
| | | for data channel |
| Q_{qualminC} | is | Minimum required quality level in the cell (decibels) |
| | | for a control channel |
| Q_{rxlevminoffset} | is | Offset to the signaled Qᵣₓₗₑᵥₘᵢₙ taken into account in |
| | | the Srxlev evaluation as a result of a periodic search |
| | | for a higher priority public land mobile network |
| | | while camped normally in a visited public |
| | | land mobile network |
| Q_{qualminoffsetD} | is | Offset to the signalled Q_{qualmin}D taken into account |
| | | in the Squal_D evaluation as a result of a periodic |
| | | search for a higher priority public land mobile |
| | | network while camped normally in a visited public |
| | | land mobile network |
| Q_{qualminoffsetC} | is | Offset to the signalled Q_{qualmin}C taken into account |
| | | in the Squal_C evaluation as a result of a periodic |
| | | search for a higher priority public land mobile |
| | | network while camped normally in a visited public |
| | | land mobile network |
| Pcompensation | is | max(P_{EMAX}_{_{—}}_{H} − P_{PowerClass}, 0) (decibels) |
| P_{EMAX}_{_{—}}_{H} | is | Maximum transmission power level a user |
| | | equipment uses when transmitting on the uplink in |
| | | the cell (decibels) defined as P_{EMAX}_{_{—}}_{H} in [technical |
| | | specification 36.101] |
| P_{PowerClass} | is | Maximum radio frequency output power of the user |
| | | equipment (decibels) according to the user |
| | | equipment power class as defined in [technical |
| | | specification 36.101] |

7. The UE of claim 1 wherein the cell ranking criterion comprises an Rs for a serving cell and an Rn for neighboring cells, and wherein the cell ranking criterion is defined as one of:
Rₛ=PL_{meas,s}+Q_{Hyst—}PL
Rₙ=PL_{meas,n}−Qoffset_PL (2)
or
Rₛ=Q_{meas,s}+Q_{Hyst}
Rₙ=Q_{meas,n}−Qoffset1−Qoffset (8)
where:

| | | |
|---|---|---|
| PLmeas,s | is | Pathloss measurement quantity in the serving cell used in |
| | | cell selection or reselection. |
| PLmeas,n | is | Pathloss measurement quantity in neighbouring cell used in |
| | | cell reselections. |
| QHyst_PL | is | The hysteresis value for ranking criteria, broadcast in |
| | | serving cell system information |
| Qoffset_PL | is | For intra-frequency: Equals to Qoffset_pls, n, if Qoffset_pls, n is valid, |
| | | otherwise this equals to zero. |
| | | For inter-frequency: Equals to Qoffset_pls, n plus |
| | | Qoffsetfrequency, if Qoffsets, n is valid, otherwise this equals |
| | | to Qoffsetfrequency. |
| Q_{meas,s} | is | Reference Signal Received Power measurement quantity in |
| | | the serving cell used in cell reselections. |
| Q_{meas,n} | is | Reference Signal Received Power measurement quantity in |
| | | the neighbouring cell used in cell selection or reselection. |
| Qoffset1 | is | Defined as the reference signal power difference between |
| | | two cells n, s, that is, ReferenceSiganlPower_n − |
| | | ReferenceSignalPower_s. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, |
| | | if Qoffset_{s,n} is valid, otherwise this equals to Qoffset_{frequency}. |
| Q_Hyst | is | Specifies the hysteresis value for ranking criteria, broadcast |
| | | in serving cell system information |

8. The UE of claim 7 wherein Qoffset1 and Qoffset are used in equation 8 when the UE experiences a certain channel quality condition while Qoffset1 is omitted when the UE experiences another channel quality condition.

9. The UE of claim 8, wherein the certain channel quality condition comprises when the channel quality received at the UE is above a threshold.

10. The UE of claim 8, wherein the another channel quality condition comprises when the channel quality received at the UE is below a threshold.

11. The UE of claim 8, wherein the certain channel quality condition comprises when the UE succeeds in decoding at least one of a control channel and a data channel with a given packet loss rate.

12. The UE of claim 8, wherein the another channel quality condition comprises when the UE fails to decode at least one of control channel and data channel with a given packet loss rate.

13. The UE of claim 1 wherein the cell selection or reselection criteria comprises a biased path loss metric.

14. The UE of claim 13 wherein the cell selection or reselection criterion fulfills the criteria defined as Srxlev>0 AND Squal_D>0 AND Squal_C>0, wherein
Srxlev=Qᵣₓₗₑᵥₘₑₐₛ−(Qᵣₓₗₑᵥₘᵢₙ+Q_{rxlevminoffset})−Pcompensation
Squal_{—}D=Q_{qualmeasD}−(Q_{qualminD}+Q_{qualminoffsetD})
Squal_{—}C=Q_{qualmeasC}−(Q_{qualminC}+Q_{qualminoffsetC})
and

| | | |
|---|---|---|
| Srxlev | is | Cell selection reception power level value (decibels) |
| Squal_D | is | Cell selection quality value (decibels) for a data |
| | | channel. |
| Squal_C | is | Cell selection quality value (decibels) for a control |
| | | channel. |
| Qᵣₓₗₑᵥₘₑₐₛ | is | Measured cell reception power level value |
| | | (Reference Signal Received Power) |
| Q_{qualmeasD} | is | Measured cell quality value (Reference Signal |
| | | Received Quality) for a data channel |
| Q_{qualmeasC} | is | Measured cell quality value (Reference Signal |
| | | Received Quality) for a control channel |
| Qᵣₓₗₑᵥₘᵢₙ | is | Minimum required reception power level in the cell |
| | | (decibels) |
| Q_{qualminD} | is | Minimum required quality level in the cell (decibels) |
| | | for data control |
| Q_{qualminC} | is | Minimum required quality level in the cell (decibels) |
| | | for a control channel |
| Q_{rxlevminoffset} | is | Offset to the signaled Qᵣₓₗₑᵥₘᵢₙ taken into account in |
| | | the Srxlev evaluation as a result of a periodic search |
| | | for a higher priority public land mobile network |
| | | while camped normally in a visited public |
| | | land mobile network |
| Q_{qualminoffsetD} | is | Offset to the signalled Q_{qualmin}D taken into account |
| | | in the Squal_D evaluation as a result of a periodic |
| | | search for a higher priority public land mobile |
| | | network while camped normally in a visited public |
| | | land mobile network |
| Q_{qualminoffsetC} | is | Offset to the signalled Q_{qualmin}C taken into account |
| | | in the Squal_C evaluation as a result of a periodic |
| | | search for a higher priority public land mobile |
| | | network while camped normally in a visited public |
| | | land mobile network |
| Pcompensation | is | max(P_{EMAX}_{_{—}}_{H} − P_{PowerClass}, 0) (decibels) |
| P_{EMAX}_{_{—}}_{H} | is | Maximum transmission power level a user |
| | | equipment uses when transmitting on the uplink in |
| | | the cell (decibels) defined as P_{EMAX}_{_{—}}_{H} in [technical |
| | | specification 36.101] |
| P_{PowerClass} | is | Maximum radio frequency output power of the user |
| | | equipment (decibels) according to the user |
| | | equipment power class as defined in [technical |
| | | specification 36.101] |

15. The UE of claim 13 wherein the cell ranking criterion comprises an Rs for a serving cell and an Rn for neighboring cells, and wherein the cell ranking criterion is defined as one of:
Rₛ=Q_{meas,s}+Q_{Hyst}+Qoffset1_{—s}
Rₙ=Q_{meas,n}+Qoffset1ₙ−Qoffset (9)
where:

| | | |
|---|---|---|
| Q_{meas,s} | is | Reference Signal Received Power measurement quantity in the |
| | | serving cell s used in cell reselections. |
| Q_{meas,n} | is | Reference Signal Received Power measurement quantity in the |
| | | neighboring cell n used in cell reselections. |
| Ooffset1_s | is | Reference Signal Received Power offset value, i.e, Qoffset1_s = |
| | | Reference Signal Received Power bias for the serving cell. |
| Qoffset1_n | is | Reference Signal Received Power offset value, i.e, Qoffset1_n = |
| | | Reference Signal Received Power bias for the neighbouring cell. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, if |
| | | Qoffset_{s,n} is valid, otherwise this equals to Qoffset_{frequency}. |
| Q_Hyst | is | Specifies the hysteresis value for ranking criteria, broadcast in |
| | | serving cell system information |

or
Rₛ=Q_{meas,s}+Q_{Hyst}
Rₙ=Q_{meas,n}−Qoffset1_{—n}−Qoffset (10)
where:

| | | |
|---|---|---|
| Q_{meas,s} | is | Reference Signal Received Power measurement quantity in the |
| | | serving cell s used in cell reselections. |
| Q_{meas,n} | is | Reference Signal Received Power measurement quantity in the |
| | | neighbouring cell n used in cell reselections. |
| Qoffset1_n | is | Defined as the reference of Reference Signal Received Power bias |
| | | between two cells s, n, i.e, bias_s − bias_n. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, if |
| | | Qoffset_{s,n} is valid, otherwise this equals to Qoffset_{frequency}. |
| Q_Hyst | is | Specifies the hysteresis value for ranking criteria, broadcast in |
| | | serving cell system information |

16. The UE of claim 15 wherein Qoffset1ₙ together with Qoffset are used by the UE to use path loss based cell selection or reselection when a coverage hole is not detected, and where Qoffset is used by the UE to use best power based cell selection or reselection as a fall back mechanism when a coverage hole is detected.

17. The UE of claim 16 wherein the coverage hole is detected when a packet error rate over a downlink transmission or an uplink transmission is above a predetermined packet error rate, and wherein the coverage hole is also detected when a received signal quality over the downlink transmission or the uplink transmission is above a predetermined received signal quality.

18. The UE of claim 17 wherein detection of the coverage hole is checked by measuring a success rate or failure rate over one or more downlink or uplink control channels.

19. The UE of claim 18 wherein the one or more downlink or uplink control channels are configured to assist detection of the coverage hole.

20. The UE of claim 15 wherein Qoffset1_n and Qoffset are used in Rn criteria (10) when the UE experiences a certain channel quality condition while Qoffset1 is omitted when the UE experiences another channel quality condition.

21. The UE of claim 20, wherein the certain channel quality condition comprises when the channel quality received at the UE is above a threshold.

22. The UE of claim 20, wherein the another channel quality condition comprises when the channel quality received at the UE is below a threshold.

23. The UE of claim 20, wherein the certain channel quality condition comprises when the UE succeeds in decoding at least one of a control channel and a data channel with a given packet loss rate.

24. The UE of claim 20, wherein the another channel quality condition comprises when the UE fails to decode at least one of a control channel and a data channel with a given packet loss rate.

25. A method comprising:
a user equipment (UE) performing one of cell selection or reselection according to a received signal quality criterion that considers both a control channel signal quality and a data channel signal quality.

26. The method of claim 25 further comprising:
performing the cell selection or reselection according to a cell ranking criterion.

27. The method of claim 25 further comprising:
performing the cell selection or reselection to one of a low power access node, a pico access node, and a femto access node.

28. The method of claim 25 wherein the received signal quality criterion further comprises a path loss based metric.

29. The method of claim 28 wherein path loss is defined by a reference signal transmit power level minus a higher layered filtered reference signal received power.

30. The method of claim 28 wherein the cell selection or reselection criterion fulfills the criteria defined as Srxlev>0 AND Squal_D>0 AND Squal_C>0, wherein
Srxlev=Qᵣₓₗₑᵥₘₑₐₛ−(Qᵣₓₗₑᵥₘᵢₙ+Q_{rxlevminoffset})−Pcompensation
Squal_{—}D=Q_{qualmeasD}−(Q_{qualminD}+Q_{qualminoffsetD})
Squal_{—}C=Q_{qualmeasC}−(Q_{qualminC}+Q_{qualminoffsetC})
and

| | | |
|---|---|---|
| Srxlev | is | Cell selection reception power level value (decibels) |
| Squal_D | is | Cell selection quality value (decibels) for a data |
| | | channel |
| Squal_C | is | Cell selection quality value (decibels) for a control |
| | | channel |
| Qᵣₓₗₑᵥₘₑₐₛ | is | Measured cell reception power level value |
| | | (Reference Signal Received Power) |
| Q_{qualmeasD} | is | Measured cell quality value (Reference Signal |
| | | Received Quality) for a data channel |
| Q_{qualmeasC} | is | Measured cell quality value (Reference Signal |
| | | Received Quality) for a control channel |
| Qᵣₓₗₑᵥₘᵢₙ | is | Minimum required reception power level in the cell |
| | | (decibels) |
| Q_{qualminD} | is | Minimum required quality level in the cell (decibels) |
| | | for a data channel |
| Q_{qualminC} | is | Minimum required quality level in the cell (decibels) |
| | | for a control channel |
| Q_{rxlevminoffset} | is | Offset to the signaled Qᵣₓₗₑᵥₘᵢₙ taken into account |
| | | in the Srxlev evaluation as a result of a periodic |
| | | search for a higher priority public land |
| | | mobile network while camped normally in a |
| | | visited public land mobile network |
| Q_{qualminoffsetD} | is | Offset to the signalled Q_{qualmin}D taken into account |
| | | in the Squal_Devaluation as a result of a periodic |
| | | search for a higher priority public land mobile |
| | | network while camped normally in a visited public |
| | | land mobile network |
| Q_{qualminoffsetC} | is | Offset to the signalled Q_{qualmin}C taken into account |
| | | in the Squal_C evaluation as a result of a periodic |
| | | search for a higher priority public land mobile |
| | | network while camped normally in a visited public |
| | | land mobile network |
| Pcompensation | is | max(P_{EMAX}_{_{—}}_{H} − P_{PowerClass}, 0) (decibels) |
| P_{EMAX}_{_{—}}_{H} | is | Maximum transmission power level a user |
| | | equipment uses when transmitting on the uplink in |
| | | the cell (decibels) defined as P_{EMAX}_{_{—}}_{H} in [technical |
| | | specification 36.101] |
| P_{PowerClass} | is | Maximum radio frequency output power of the user |
| | | equipment (decibels) according to the user |
| | | equipment power class as defined in [technical |
| | | specification 36.101] |

31. The method of claim 25 wherein the cell ranking criterion comprises an Rs for a serving cell and an Rn for neighboring cells, and wherein the cell ranking criterion is defined as one of:
Rₛ=PL_{meas,s}+Q_{Hyst—}PL
Rₙ=PL_{meas,n}−Qoffset_PL (2)
or
Rₛ=Q_{meas,s}+Q_{Hyst}
Rₙ=Q_{meas,n}−Qoffset1−Qoffset (8)
where:

| | | |
|---|---|---|
| PLmeas | is | Pathloss measurement quantity used in cell reselections. |
| QHyst_PL | is | The hysteresis value for ranking criteria, broadcast in |
| | | serving cell system information |
| Qoffset_PL | is | For intra-frequency: Equals to Qoffset_pls, n, if Qoffset_pls, n is |
| | | valid, otherwise this equals to zero. |
| | | For inter-frequency: Equals to Qoffset_pls, n plus |
| | | Qoffsetfrequency, if Qoffsets, n is valid, otherwise this equals |
| | | to Qoffsetfrequency. |
| Qₘₑₐₛ | is | Reference Signal Received Power measurement quantity |
| | | used in cell reselections. |
| Qoffset1 | is | Defined as the reference signal power difference between |
| | | two cells n, s, that is, ReferenceSiganlPower_n − |
| | | ReferenceSignalPower_s. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, |
| | | if Qoffset_{s,n} is valid, otherwise this equals to Qoffset_{frequency}. |
| Q_Hyst | is | Specifies the hysteresis value for ranking criteria, broadcast |
| | | in serving cell system information |

32. The method of claim 31 wherein Qoffset1 and Qoffset are used in equation 8 when the UE experiences a certain channel quality condition while Qoffset1 is omitted when the UE experiences another channel quality condition.

33. The method of claim 32, wherein the certain channel quality condition comprises when the channel quality received at the UE is above a threshold.

34. The method of claim 32, wherein the another channel quality condition comprises when the channel quality received at the UE is below a threshold.

35. The method of claim 32, wherein the certain channel quality condition comprises when the UE succeeds in decoding at least one of a control channel and a data channel with a given packet loss rate.

36. The method of claim 32, wherein the another channel quality condition comprises when the UE fails to decode at least one of control channel and data channel with a given packet loss rate.

37. The method of claim 25 wherein the cell selection or reselection criteria comprises a biased path loss metric.

38. The method of claim 37 wherein the cell selection or reselection criterion fulfills the criteria defined as Srxlev>0 AND Squal_D>0 AND Squal_C>0, wherein
Srxlev=Qᵣₓₗₑᵥₘₑₐₛ−(Qᵣₓₗₑᵥₘᵢₙ+Q_{rxlevminoffset})−Pcompensation
Squal_{—}D=Q_{qualmeasD}−(Q_{qualminD}+Q_{qualminoffsetD})
Squal_{—}C=Q_{qualmeasC}−(Q_{qualminC}+Q_{qualminoffsetC})
and

| | | |
|---|---|---|
| Srxlev | is | Cell selection reception power level value (decibels) |
| Squal_D | is | Cell selection quality value (decibels) for a data |
| | | channel |
| Squal_C | is | Cell selection quality value (decibels) for a control |
| | | channel |
| Qᵣₓₗₑᵥₘₑₐₛ | is | Measured cell reception power level value |
| | | (Reference Signal Received Power) |
| Q_{qualmeasD} | is | Measured cell quality value (Reference Signal |
| | | Received Quality) for data a channel |
| Q_{qualmeasC} | is | Measured cell quality value (Reference Signal |
| | | Received Quality) for a control channel |
| Qᵣₓₗₑᵥₘᵢₙ | is | Minimum required reception power level in the cell |
| | | (decibels) |
| Q_{qualminD} | is | Minimum required quality level in the cell (decibels) |
| | | for a data channel |
| Q_{qualminC} | is | Minimum required quality level in the cell (decibels) |
| | | for a control channel |
| Q_{rxlevminoffset} | is | Offset to the signaled Qᵣₓₗₑᵥₘᵢₙ taken into account in |
| | | the Srxlev evaluation as a result of a periodic search |
| | | for a higher priority public land mobile network |
| | | while camped normally in a visited public |
| | | land mobile network |
| Q_{qualminoffsetD} | is | Offset to the signalled Q_{qualmin}D taken into account |
| | | in the Squal_D evaluation as a result of a periodic |
| | | search for a higher priority public land mobile |
| | | network while camped normally in a visited public |
| | | land mobile network |
| Q_{qualminoffsetC} | is | Offset to the signalled Q_{qualmin}C taken into account |
| | | in the Squal_C evaluation as a result of a periodic |
| | | search for a higher priority public land mobile |
| | | network while camped normally in a visited public |
| | | land mobile network |
| Pcompensation | is | max(P_{EMAX}_{_{—}}_{H} − P_{PowerClass}, 0) (decibels) |
| P_{EMAX}_{_{—}}_{H} | is | Maximum transmission power level a user |
| | | equipment uses when transmitting on the uplink in |
| | | the cell (decibels) defined as P_{EMAX}_{—}_{H} in [technical |
| | | specification 36.101] |
| P_{PowerClass} | is | Maximum radio frequency output power of the user |
| | | equipment (decibels) according to the user |
| | | equipment power class as defined in [technical |
| | | specification 36.101] |

39. The method of claim 37 wherein the cell ranking criterion comprises an Rs for a serving cell and an Rn for neighboring cells, and wherein the cell ranking criterion is defined as one of:
Rₛ=Q_{meas,s}+Q_{Hyst}+Qoffset1_{—s}
Rₙ=Q_{meas,n}+Qoffset1ₙ−Qoffset (9)

| | | |
|---|---|---|
| Q_{meas,s} | is | Reference Signal Received Power measurement quantity in the |
| | | serving cell s used in cell reselections. |
| Q_{meas,n} | is | Reference Signal Received Power measurement quantity in the |
| | | neighboring cell n used in cell reselections. |
| Ooffset1_s | is | Reference Signal Received Power offset value, i.e, Qoffset1_s = |
| | | Reference Signal Received Power bias for the serving cell. |
| Qoffset1_n | is | Reference Signal Received Power offset value, i.e, Qoffset1_n = |
| | | Reference Signal Received Power bias for the neighbouring cell. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, if |
| | | Qoffset_{s,n} is valid, otherwise this equals to Qoffset_{frequency}. |
| Q_Hyst | is | Specifies the hysteresis value for ranking criteria, broadcast in |
| | | serving cell system information |

or
Rₛ=Q_{meas,s}+Q_{Hyst}
Rₙ=Q_{meas,n}−Qoffset1_{—n}−Qoffset (10)
where:

| | | |
|---|---|---|
| Qₘₑₐₛ | is | Reference Signal Received Power measurement quantity used in |
| | | cell reselections. |
| Qoffset1_n | is | Defined as the reference of Reference Signal Received Power bias |
| | | between two cells s, n, i.e, bias_s − bias_n. |
| Qoffset | is | For intra-frequency: Equals to Qoffset_{s,n}, if Qoffset_{s,n} is valid, |
| | | otherwise this equals to zero. |
| | | For inter-frequency: Equals to Qoffset_{s,n} plus Qoffset_{frequency}, if |
| | | Qoffset_{s,n} is valid, otherwise this equals to Qoffset_{frequency}. |
| Q_Hyst | is | Specifies the hysteresis value for ranking criteria, broadcast in |
| | | serving cell system information |

40. The method of claim 39 wherein Qoffset1ₙ together with Qoffset are used by the UE to use path loss based cell selection or reselection when a coverage hole is not detected, and where Qoffset is used by the UE to use best power based cell selection or reselection as a fall back mechanism when a coverage hole is detected.

41. The method of claim 40 wherein the coverage hole is detected when a packet error rate over a downlink transmission or an uplink transmission is above a predetermined packet error rate, and wherein the coverage hole is also detected when a received signal quality over the downlink transmission or the uplink transmission is above a predetermined received signal quality.

42. The method of claim 41 wherein detection of the coverage hole is checked by measuring a success rate or failure rate over one or more downlink or uplink control channels.

43. The UE of claim 42 wherein the one or more downlink or uplink control channels are configured to assist detection of the coverage hole.

44. The method of claim 39 wherein Qoffset1_n and Qoffset are used in Rn criteria (10) when the UE experiences a certain channel quality condition while Qoffset1 is omitted when the UE experiences another channel quality condition.

45. The method of claim 44, wherein the certain channel quality condition comprises when the channel quality received at the UE is above a threshold.

46. The method of claim 44, wherein the another channel quality condition comprises when the channel quality received at the UE is below a threshold.

47. The method of claim 44, wherein the certain channel quality condition comprises when the UE succeeds in decoding at least one of a control channel and a data channel with a given packet loss rate.

48. The method of claim 44, wherein the another channel quality condition comprises when the UE fails to decode at least one of a control channel and a data channel with a given packet loss rate.
